(19) United States
(12) Patent Application Publication
(10) Pub. No.: US 2008/0072072 A1
(43) Pub. Date: Mar. 20, 2008

(54) Recording Device and Recording Method

(76) Inventors: Kenji Muraki, Osaka (JP); Hideshi Ishihara, Osaka (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 11/570,072

(22) PCT Filed: Jun. 5, 2005
(86) PCT No.: PCT/JP05/10506

§ 371 Date: Dec. 6, 2006

(30) Foreign Application Priority Data
Jun. 9, 2004 (JP) 2004-170773

(51) Int. Cl. G06F 12/14

(52) U.S. Cl. 713/193

(57) ABSTRACT

To prevent the user from moving a content on a bound recording medium to another storage medium more than the maximum number of times permitted by its copyright holder.

A recorder includes: a bound recording section for bound-recording at least one data file and at least one management information file for a content; a control section for giving an instruction to move the content to a storage medium; and a drive for recording the content's data on the storage medium. The management information file includes access information for accessing the data file. In response to the instruction to move, the bound recording section reads the data file of the content in accordance with the access information and outputs the content's data, the drive records the content's data on the storage medium, and the control section makes the access information unavailable.

### TECHNICAL FIELD

The present invention relates to recording a content that has been digitally broadcast, electronically distributed, or read out from a pre-recorded medium.

### BACKGROUND ART

Recently, more and more contents are provided as digital ones. Likewise, BS, CS, terrestrial broadcasting and CATV inside and outside Japan and tapes and disks for recording them have been switched into digital ones. Meanwhile, recording on a semiconductor storage medium has also become popular.

Digital recording effectively contributes to copying a high-quality content without debasing its quality. However, unlimited copying of a content would infringe its copyright. That is why a digital recorder is now required to have a copyright protection function.

As a digital copyright protection function, Serial Copy Management System (SCMS) has been used extensively in digital audio equipment since 1980s. The SCMS has been superposed on a signal at a digital audio output or internal connection in players for read-only media such as compact discs (CDs), laser disks and digital versatile disks (DVDs), players for various storage media including digital audio tape recorders (DATs), mini discs (MDs), audio CD-Rs, CD-RWs, DVD-RAMs, DVD-RWs, DVD-Rs, DVD+RWs, DVD+Rs, Blu-ray discs (BDs) and HD-DVDs, and in receivers for BS analog broadcasting, BS, CS and terrestrial digital broadcasting. The SCMS has also been used for the purpose of recording control in various recorders for MDs, DATs, audio CD-Rs, CD-RWs and SDs.

According to the SCMS, copy generation information is provided as additional information for a digital audio signal, thereby controlling the copy generation. More specifically, “copy free”, “copy one generation” and “copy never” are defined. In the recorder, (1) if the input signal is “copy free”, then the signal is copied as “copy free” material, (2) if the input signal is “copy one generation”, then the signal is copied only once and updated into “copy never”, and (3) if the input signal is “copy never”, then the signal is not copied at all.

In the SCMS, once a content has been copied and updated into “copy never”, the content may not be copied anymore. For example, in a device for receiving a digital broadcast and recording it on an HDD, which is included in the same housing as the receiver, if the broadcast content is “copy one generation”, then that content is stored on the HDD after having been updated into “copy never”. The HDD has only a limited storage capacity and allows the user to store just a limited number of contents. Also, a device of this type is often a fixed one that is supposed to be driven with AC power supply. However, since the content on the HDD is “copy never”, the content may not be copied elsewhere anymore. This is a restriction that must be imposed for the purpose of copyright protection. Still, it is inconvenient for the users considering that the storage medium is the hard disk drive (HDD) that forms an integral part of the device.

In view of this inconvenience, a “content move” operation has been proposed. To “move” a content means transferring the content from one location to another by copying a “copy never” content, which is stored on a storage medium, to another storage medium and then making the content, remaining on the original storage medium, non-playable.

Hereinafter, a conventional move process as disclosed in Patent Document No. 1 will be described. The example disclosed in this document relates to an audio content.

The SDMI (Secure Digital Music Initiative, which is a group comprised of content holders, consumer electronics device makers, computer makers and so on), reached an agreement to set several guidelines on how to protect the copyright of content providers in a situation where a user attempts to copy a content that has been distributed by an electronic music distribution system from one medium to another. According to this agreement, a content provider defines in advance attribute information called a “checkout count” for each content, distributes the content to users, and then each of those users gets the distributed content received by his or her personal computer (PC) and stored on a storage medium (such as an HDD) in the PC. This HDD is treated as a server.

Also, according to the SDMI, the user can not only play the distributed content using his or her PC but also copy it from his or her PC to a portable device (PD) or a portable medium (PM) and play it by making checkouts up to the maximum number of checkouts and check-ins. In that case, every time he or she makes a checkout, the checkout counter is decremented. The number of times he or she can make checkouts is no greater than the checkout count. The user can also increase the checkout count by returning unnecessary contents from the PD or PM to the PC (i.e., by making a check-in).

In the prior art, a recording operation compliant with the SDMI has been carried out as follows. Specifically, by supposing there are the same number of virtual files as the maximum number of copies (i.e., the number of copy media) granted to the user by the copyright holder, the virtual files are moved without “copying” the content. That is to say, although a content provider may actually distribute a single content (with a number of copies of four) to the user, the content is supposed to be distributed as four virtual files of the same content. And when the user copies the content from one medium to another, it is not understood that the real content has been copied but that one of those virtual files is moved by decrementing the copyright counter at the source and incrementing the copyright counter at the destination. Accordingly, if a content with a number of copies of one is copied, then one virtual file is moved and the virtual file is erased (i.e., the number of copies is now zero) and neither played nor moved anymore at the source.

FIG. 23(a) shows that a content with a number of copies of four has been distributed to a medium A and that four virtual files M are now stored on the medium A. FIG. 23(b) shows an example in which a content with a number of copies of two is copied from the content with a number of copies of four, which has been distributed to the medium A, to another medium B in the state shown in FIG. 23(a). In this example, two virtual files M are supposed to have been moved from the medium A to the medium B. As a result of the move of these two virtual files M, two virtual files M (with a number of copies of two) are now stored on each of the two media A and B. FIG. 23(c) shows a situation where a content with a number of copies of one is copied from the content with the number of copies of two, which has been moved to the medium B, to still another medium C in the state shown in FIG. 23(b). In that case, just one virtual file M is moved from the medium B to the medium C. As a result of the move of this one virtual file M, one virtual file M (with a number of copies of one) is now stored on each of the two media B and C.

FIG. 23(d) shows a situation where a content with a number of copies of one is copied from the medium C to yet another medium D in the state shown in FIG. 23(c). In that case, just one virtual file M is moved from the medium C to the medium D. As a result of the move of this virtual file M, the medium C now has a number of copies of zero and no virtual files H at all. That is to say, the virtual file M has been erased from the medium C (i.e., the virtual file H can neither be played nor moved from the medium C anymore). FIG. 23(e) shows a situation where the content with the number of copies of one, which was moved from the medium A to the medium B in FIG. 23(b), is returned (or moved back) to the medium A in the state shown in FIG. 23(d). As a result of the move of this virtual file M, the medium A now has a number of copies of three (i.e., has three virtual files M) but the medium B now has a number of copies of zero and no virtual files M at all. That is to say, the virtual file M has been erased from the medium B (i.e., the virtual file M can neither be played nor moved from the medium B anymore).

In copying a content (i.e., in moving a virtual file M), either a device including these media A through D or the media A through D themselves authenticate each other as devices (or media) that follow appropriate copyright protection rules so as to comply with the SDMI rules and pass the content only when the authentication is done successfully. In this case, the specific details of copyright management information are not defined by the SDMI rules, and therefore, this conventional method follows the SDMI rules.

According to the conventional method, however, when a content should be moved to a medium that adopts a different recording format, the content cannot be moved while being given a full protection, which is a problem.

Suppose the recorder/player 2101 shown in FIG. 24 has received an AV content with a number of copies of three that has been transmitted as an MPEG2-TS (transport stream) through digital broadcasting.

In this description, a recording/playback function allowing the user to play back a content with only the device that was used to record it will be referred to herein as “bound recording”; to store a content on a removable storage medium such as a tape, a disk or a semiconductor medium, which has an independent form that allows the user to remove it from a device and to get it played by another device with a playback function will be referred to herein as “recording”; and a bound-recorded or recorded content will be referred to herein as a “file”.

FIG. 24 shows an arrangement of functional blocks in the conventional recorder/player 2101. The recorder/player 2101 includes a receiving section 2102, a bound recording section 2103 for bound-recording a received content as a virtual file, a first converting section 2104 for converting the virtual file, a first storage medium 2105 for recording the file that has been converted by the first converting section 2104, a second converting section 2106 for converting the virtual file, a second storage medium 2107 for recording the file that has been converted by the second converting section 2106, a third storage medium 2108 for recording a bound-recorded file, and a user interface 2109. The user interface 2109 is used to get the respective operations to be described below started or to present options of information needed for those operations and make a selection.

The bound recording section 2103 bound-records a broadcast content, which has been designated through the user interface 2109 among the broadcast contents that have been received by the receiving section 2102, as three virtual files as they are (i.e., as MPEG2-TS). Depending on the broadcast distributing conditions, the broadcast content may sometimes need to be encrypted before being bound-recorded. For example, if the broadcast content has been distributed as “copy one generation”, then the content is bound-recorded and updated into “copy never”.

In this example, the first storage medium 2105 is supposed to be an SD memory card, the second storage medium 2107 a DVD-RAM, and the third storage medium 2108 a D-VHS, respectively.

The SD-Video standard was set as a method of recording an AV content on an SD memory card. According to the SD-Video standard, the coding method should be compliant with either the MPEG2-PS (program stream) standard or the MPEG-4 standard. That is why the first converting section 2104 converts the MPEG2-TS into either an MPEG2-PS or an MPEG-4 stream as specified by the user through the user interface 2109. On the other hand, when the AV content is recorded on the DVD-RAM, the Video Recording (VR) format should be adopted and the coding method should be compliant with the MPEG2-PS (program stream) standard. Thus, the second converting section 2106 converts the MPEG2-TS into an MPEG2-PS. Meanwhile, the D-VHS records the incoming MPEG2-TS as it is.

According to the conventional method, however, no special restrictions are imposed on the destinations of files to move. That is why all of the three virtual files may be moved to the DVD-RAM, for example.
Patent Document No. 1: Japanese Patent Application Laid-Open Publication No. 2002-358241

### DISCLOSURE OF INVENTION

### Problems to be Solved by the Invention

If multiple virtual files in the same recording format were generated in a bound recording medium, however, the copyright could be infringed more easily. That is to say, if a number of files in the same recording format were generated, there would be a risk that all of those files might be moved to multiple storage media of the same type. And such storage media created in this way could be put on sale illegally, thus increasing the risk of copyright infringement.

To avoid such a risk, some content providers set a condition on bound recording that when a content is bound-recorded, more than one file in the same recording format should not be generated.

### Means for Solving the Problems

A recorder according to the present invention includes: a bound recording section for bound-recording at least one data file and at least one management information file about a content; a control section for giving an instruction to move the content to a storage medium; and a drive for recording the content's data on the storage medium. The management information file includes access information for accessing the data file. In response to the instruction to move, the bound recording section reads the data file of the content in accordance with the access information and outputs the content's data, the drive records the content's data on the storage medium, and the control section makes the access information unavailable.

The control section may generate access information for accessing the content's data that has been recorded on the storage medium, and the drive may record the generated access information on the storage medium.

The management information file may include storage medium information that shows a storage medium, to which the content's move has been permitted, the bound recording section may read the storage medium information, and the control section may generate and output data to present the storage medium information that has been read.

The management information file may include format information that specifies a recording format, in which the move has been permitted, the bound recording section may read the format information, and the control section may generate and output data to present the format information that has been read.

The data file may have been encrypted and the management information file may include key information for decoding the data file. The bound recording section may read the key information. The drive may decode the data file with the key information that has been read, encrypt the data file again with a different type of key information from the key information, and then record the content's data on the storage medium.

The data file may have been encrypted and the management information file may include key information for decoding the data file. The bound recording section may read the key information and the drive may further record the read key information on the storage medium.

The bound recording section may bound-record a number of management information files that has been specified by the content's provider.

The bound recording section may bound-record a plurality of data files and pieces of management information files, each of which has a one-to-one relationship with an associated one of the data files. The control section may give the instruction to move and designate one of the data files that includes the content to be moved. The bound recording section may read and output the designated data file. The drive may record the read data on the storage medium. And the control section may make unavailable at least the access information of the management information file associated with the data file that has been read.

The bound recording section may bound-record a first management information file, a second management information file, and a data file. Each of the first and second management information files may include access information for accessing the data file. The control section may give an instruction to move the content based on the first management information file. The bound recording section may read the data file in accordance with the access information of the first management information file. And the control section may make at least the access information of the first management information file unavailable.

The control section may further give an instruction to move the content. The bound recording section may read the data file in accordance with the access information of the second management information file. And the control section may make at least the access information of the second management information file unavailable.

The bound recording section may bound-record a first data file, a second data file and at least one management information file. The at least one management information file may include first access information for accessing the first data file and second access information for accessing the second data file. The control section may give an instruction to move a content included in the first data file. The bound recording section may select a first management information file from the at least one management information file and may read the first data file in accordance with the first access information included in the first management information file. And the control section may make unavailable at least the second access information of the first management information file as well as the first access information thereof.

The control section may further give an instruction to move the content included in one of the first and second data files. The bound recording section may select a second management information file, which is different from the first management information file, and may read the selected data file in accordance with the access information thereof. And the control section may make unavailable at least the first and second access information of the second management information file.

A recording method according to the present invention may include the steps of: bound-recording at least one data file about a content; bound-recording at least one management information file including access information for accessing the data file; giving an instruction to move the content to a storage medium; reading the data file of the content in accordance with the access information and outputting the content's data in response to the instruction to move; recording the content's data on the storage medium; and making the access information unavailable.

### EFFECTS OF THE INVENTION

In a recording method according to the present invention, a management information file, which points to a data file as an object of move management, is generated. In response to an instruction to move, one of the data files, to which the management information file points, is copied on a storage medium and that management information file is made unavailable. As a result, the number of moves can be limited to that of the management information files just as intended and the copyright of a content can be protected appropriately.

### BRIEF DESCRIPTION OF DRAWINGS

FIG. 1 shows an arrangement of functional blocks in a recorder 101 according to a preferred embodiment of the present invention.

FIG. 2 shows an arrangement of functional blocks in the receiving section 103.

FIG. 3(a) shows the arrangement of packets in the TS received by the MPEG-TS processing section 204 and FIG. 3(b) shows the arrangement of packets in the partial TS that has been output from the MPEG-TS processing section 204.

FIG. 4 shows an arrangement of functional blocks in the MPEG-TS processing section 204.

FIG. 5 lists the service information (SI) and program specific information (PSI) that are used in a TS.

FIG. 6 shows an exemplary data structure of a program map table PMT.

FIG. 7(a) shows the data structure of a digital copy control descriptor; FIG. 7(b) shows correspondence between a two-bit value described in the copy_control_type field and the operation of the information storage device 100 associated with that value; FIG. 7(c) shows correspondence between a two-bit value described in the digital_recording_control_data field and the operation of the information storage device 100 associated with that value; and FIG. 7(d) shows correspondence between a two-bit value described in the APS_control_data field and the operation of the information storage device 100 associated with that value.

FIG. 8(a) shows the data structure of a content availability descriptor and FIG. 8(b) shows the details of processing to be done according to the bit value in the encryption_mode field.

FIG. 9(a) shows the data structure of a service descriptor and FIG. 9(b) shows correspondence between a possible value in the service_type field and its associated service.

FIG. 10(a) shows the data structure of a copy status descriptor and FIGS. 10(b) through 10(h) show the meanings of data values in respective fields of the copy status descriptor.

FIG. 11 shows an arrangement of functional blocks in the encryption processing section 104.

FIG. 12 shows how the copyright protection information defines the bound recording operation and the operation of recording a content on a removable storage medium.

FIG. 13 shows at least one content that is bound-recorded in the bound recording section 105 and the management information associated with the content.

FIG. 14 shows two MPEG2-PS data files 107 and 109 with mutually different bit rates and two management information files 106 and 108.

FIG. 15 shows an exemplary configuration for the user interface section 115.

FIG. 16 shows an exemplary image presented on the screen during move processing.

FIG. 17 shows configurations for the first drive 112 of the recorder 101, the first storage medium 116 and the first player 1613.

FIG. 18 is a flowchart showing the procedure of content move processing.

FIG. 19 shows an example of the management information file 1611.

FIG. 20 shows configurations for the second drive 113 of the recorder 101, the second storage medium 118 and the second player 1813.

FIG. 21 shows a management information file 1901 that adopts a different data structure.

FIG. 22 shows an arrangement of functional blocks in a recorder 221 according to another preferred embodiment of the present invention.

FIG. 23 shows how a content is protected according to a conventional SDMI method.

FIG. 24 shows an arrangement of functional blocks in a conventional recorder/player 2101.

### DESCRIPTION OF REFERENCE NUMERALS

100 central processing unit (CPU)
101 recorder
102 RF signal input terminal
103 receiving section
104 encryption processing section
105 bound recording section
106 1^{st} management information file
107 1^{st} data file
108 2^{nd} management information file
109 2^{nd} data file
110 3^{rd} management information file
111 3^{rd} data file
112 1^{st} drive
113 2^{nd} drive
114 3^{rd} drive
115 user interface section
201 RF signal processing section
202 decoding section
203 management information generating section
204 MPEG-TS processing section
205 TS-PS converting section
206 MPEG 2-4 converting section
501 title key generating section
502 encryption section
1601, 1614, 1801, 1814 device key set
1602, 1615, 1815, 1802 MKB decoding processing section
1603, 1616, 1803, 1816 converting section
1604 title key generating section
1605, 1607, 1805 encryption section
1606, 1617, 1618, 1818 decoding section
1608, 1806 media key block (MKB)
1609, 1807 media ID
1610, 1810 encrypted title key
1611, 1811 management information file
1612, 1812 encrypted content data file
1613 1^{st} player
1619, 1819 MPEG decoder
1804, 1817 card authenticating section
1808 media unique key Kmu
1809 device authenticating section
1813 2^{nd} player

### BEST MODE FOR CARRYING OUT THE INVENTION

Hereinafter, preferred embodiments of the present invention will be described with reference to the accompanying drawings.

### A. DEFINITIONS OF TERMS

To store means writing data on a medium with either a storage area or a storage device and retaining that data such that the data is readily readable from the medium.

To record means storing data on a storage medium such that the data can be presented using a predetermined player. As used herein, the “predetermined player” includes not only the device that was used to record that data but also other devices with a playback function. Also, the “storage medium” is removable from the recorder and has such a shape as readily recognizable independently of that recorder. Examples of those storage media include magnetic tapes, optical disks, removable hard disks and semiconductor storage media.

To bound record means getting data stored on a storage medium by a device such that the data can be presented only with that device. In this case, the “storage medium” is supposed to be a built-in storage medium that is not usually removable (e.g., a built-in hard disk or a built-in semiconductor memory). For example, if content's data is stored by a device on a storage medium (e.g., on a built-in hard disk) after having been encrypted such that the data can be decrypted only by that device, then that data is “bound-recorded”. However, data can be “bound-recorded” even on a removable storage medium as long as this definition is applicable.

To copy means copying data, which is stored on one storage medium, to another storage medium and storing it there.

To move means transferring data, which is currently stored on one storage medium, to another storage medium and storing it there. If no copying is permitted from one storage medium to another (i.e., if “copy never”), then the data stored on the source storage medium is no longer available but only the data stored on the destination storage medium is available once the move is completed. The data has been “moved” from the source storage medium to the destination storage medium as long as the data is no longer available from the source storage medium, no matter whether that data remains in the source storage medium or not. For example, if “copy never” content data bound-recorded on a storage medium is copied to another storage medium and then made not available, then the content has been “moved”.

The “data” to be recorded, bound-recorded, copied or moved includes not only content's data but also management information for controlling the playback of that content. The content's data and management information are managed as separate files on the file system of each storage medium.

### B. CONFIGURATION OF RECORDER ACCORDING TO THIS PREFERRED EMBODIMENT

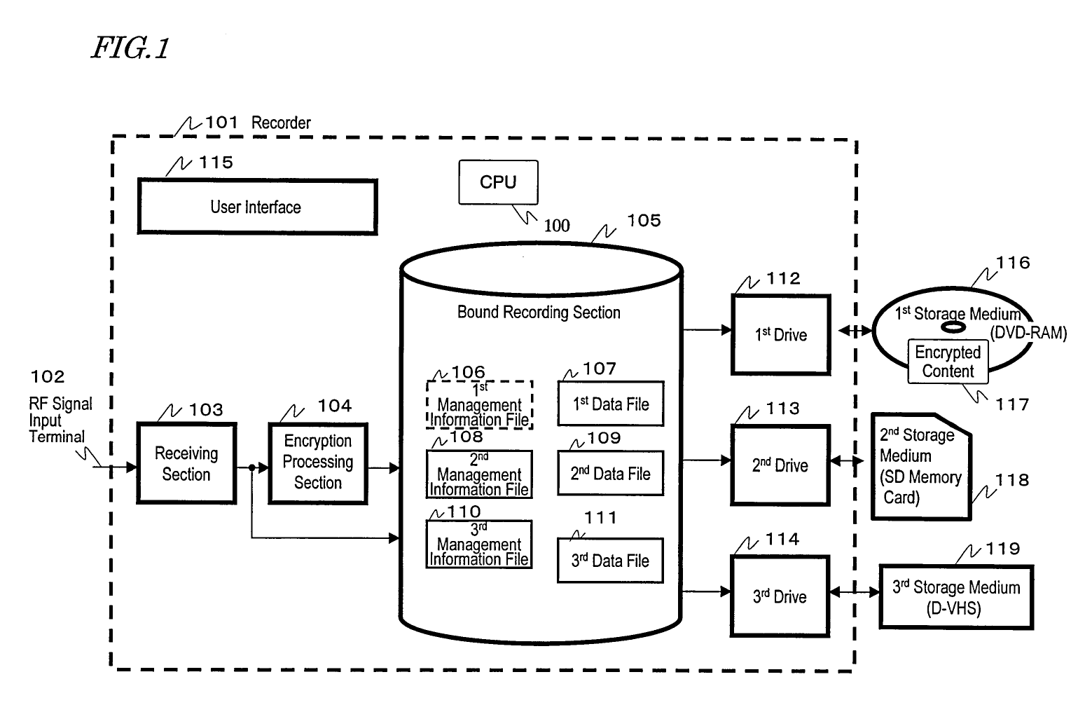

FIG. 1 shows an arrangement of functional blocks in a recorder 101 according to this preferred embodiment. The recorder 101 receives a digital broadcast program (i.e., a content including video and audio) with a number of copies set to three as an MPEG2-TS (transport stream) and can get the content moved to three types of removable storage media by way of a bound recording section 105. The three types of storage media may be a DVD-RAM, an SD memory card and a D-VHS, for example.

The recorder 101 records the content on the DVD-RAM as an MPEG2-PS (program stream) in the Video Recording format. In this case, the recorder 101 encrypts the content so as to comply with the Content Protection for Recordable Media (CPRM) standard. On the SD memory card, the recorder 101 records the content as an MPEG2-PS or an MPEG-4 stream. In that case, the recorder 101 also encrypts the content so as to comply with the CPRM standard as in the DVD-RAM. Meanwhile, on the D-VHS, the recorder 101 records the content as an MPEG-2 partial transport stream (MPEG2-PTS) compliant with the D-VHS standard.

It should be noted that a normal recorder has not just a recording function but also a playback function. Just like a normal recorder, the recorder 101 can also play back the content that has been recorded on the DVD-RAM 116, SD memory card 118 and/or D-VHS 119.

The recorder 101 includes a central processing unit (CPU) 100, an RF signal input terminal 102, a receiving section 103, an encryption processing section 104, a bound recording section 105, first, second and third drives 112, 113 and 114, and a user interface 115.

The CPU 100 controls the overall operation of the recorder 101. The processing done by the recorder 101 to be described later is carried out under the control of the CPU 100.

The RF signal input terminal 102 is connected to a digital broadcasting antenna and receives an RF signal, representing a digital broadcast, from the antenna.

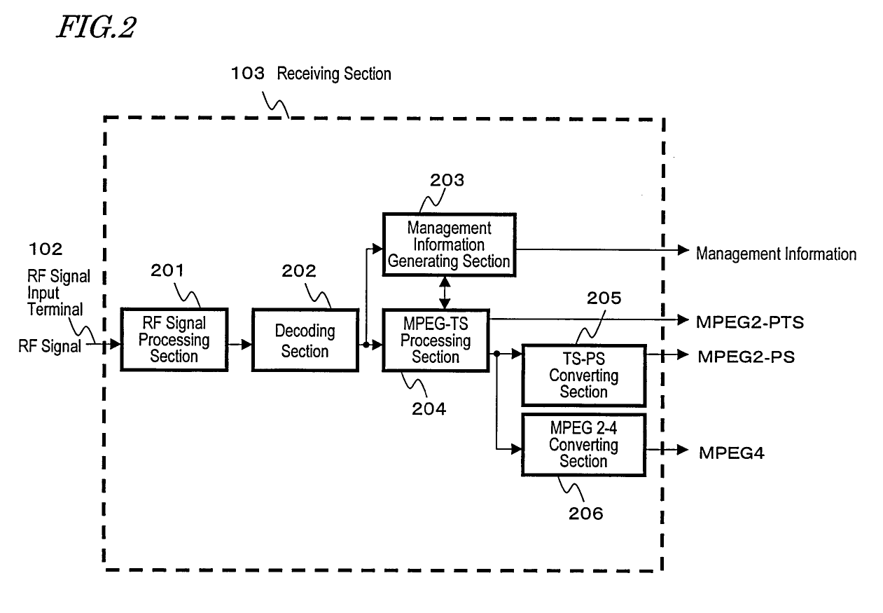

The receiving section 103 processes the RF signal, representing a broadcast wave, extracts an MPEG2-TS in which a number of services (or contents) are multiplexed together, and generates an MPEG2-PTS, in which only a particular content is included, and the content related management information. Also, the receiving section 103 converts the MPEG2-PTS into an MPEG2-PS and an MPEG-4 stream. The configuration of the receiving section 103 will be described more fully later with reference to FIG. 2.

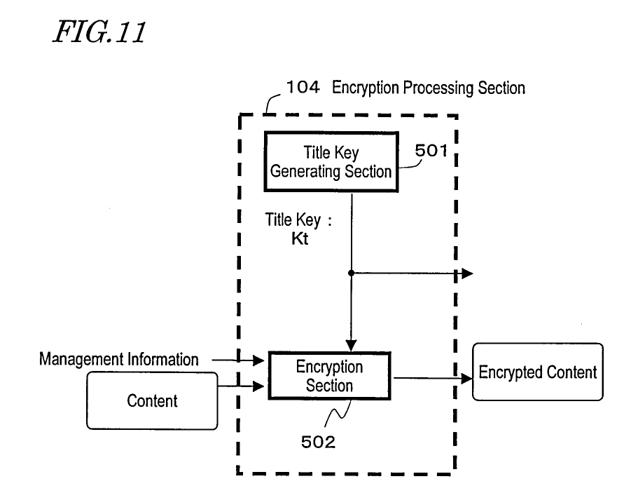

The encryption processing section 104 generates a title key as a cryptographic key on a content-by-content basis. Then, by using the title key and part of the management information, the encryption processing section 104 encrypts the content's data (i.e., the MPEG2-PS and MPEG-4 stream) that has been supplied from the receiving section 103. The configuration of the encryption processing section 104 will be described more fully later with reference to FIG. 11.

The bound recording section 105 may be a hard disk drive (HDD) or a semiconductor memory, for example. The bound recording section 105 receives non-encrypted content's data from the receiving section 103 and/or the encrypted content's data from the encryption processing section 104 and bound-records the received data there. Also, the bound recording section 105 may receive the content's data and management information from the receiving section 103 directly and bound-record them there. As a result, a first management information file 106, a first data file 107, a second management information file 108, a second data file 109, a third management information file 110 and a third data file 111 are bound-recorded in the bound recording section 105.

The first, second and third drives 112, 113 and 114 can read and write data from/on the first storage medium (e.g., DVD-RAM) 116, second storage medium (e.g., SD memory card) 118 and third storage medium (e.g., D-VHS) 119, respectively. In this case, the drives 112, 113 and 114 perform processes associated with the respective storage media in accordance with the information included in the respective management information files that are bound-recorded in the bound recording section 105. As shown in FIG. 1, an encrypted content 117 has been recorded on the first storage medium 116.

When necessary, the user interface section 115 communicates with respective components of the recorder 101, presents information to the user, and accepts inputs from the user.

### C. DETAILS OF RESPECTIVE COMPONENTS OF RECORDER AND STRUCTURES OF DATA HANDLED BY THE COMPONENTS

FIG. 2 shows an arrangement of functional blocks in the receiving section 103. The receiving section 103 includes an RF signal processing section 201, a decoding section 202, a management information generating section 203, an MPEG-TS processing section 204, a TS-PS converting section 205, and an MPEG 2-4 converting section 206. The RF signal processing section 201 receives an RF signal, extracts an encrypted MPEG2-TS from the signal, and then outputs it. In this MPEG2-TS, a number of programs (or contents) are supposed to have been multiplexed together. The decoding section 202 decrypts the encrypted MPEG2-TS that has been supplied from the RF signal processing section 201. The management information generating section 203 generates management information from the MPEG2-TS. The MPEG-TS processing section 204 generates an MPEG2-PTS from the MPEG2-TS. The TS-PS converting section 205 converts the MPEG2-PTS into an MPEG2-PS. And the MPEG 2-4 converting section 206 converts the MPEG2-PTS into an MPEG-4 stream.

In digital broadcasting within Japan, for example, an MPEG2-TS may be encrypted and broadcast for the purpose of content protection. It is to the discretion of an individual broadcaster whether the MPEG2-TS should be encrypted or not. To decrypt an encrypted broadcast, an IC card called a “B-CAS card” (not shown) needs to be inserted into a receiver. And to be supplied with the B-CAS card, the receiver needs to be compliant with the Association of Radio Industries and Businesses (ARIB) standard. More particularly, the receiver needs to satisfy the content protection specifications that are set forth in the ARIB TR-B14 (terrestrial digital broadcasting) and TR-B15 (BS/broadband Cs digital broadcasting) standards.

By reference to the data in the B-CAS card, the decoding section 202 decrypts the code, thereby outputting a decrypted MPEG2-TS. From the standpoint of content protection, it is prohibited to output the unencrypted MPEG2-TS, which has been decrypted, to a PCI bus, for example, which can be accessed by users easily. For that reason, a fixed receiver for general consumers, for instance, outputs the decrypted MPEG2-TS through a dedicated in-substrate line. If the recorder is installed into a personal computer (PC) using a general purpose bus such as a PCI bus, the content is protected by encrypting the content differently on the PCI bus from the cryptography used in the B-CAS.

The MPEG-TS processing section 204 extracts only the data about a designated program from the multiplexed MPEG2-TS, thereby generating an MPEG2-PTS. More specifically, the MPEG-TS processing section 204 gets data packets, concerning the designated program, selected by the user interface section 115 and extracts necessary information from the packets in which a table of program association information is stored. Then, by editing the extracted information, the MPEG-TS processing section 204 re-compiles a table of program association information for the MPEG2-PTS.

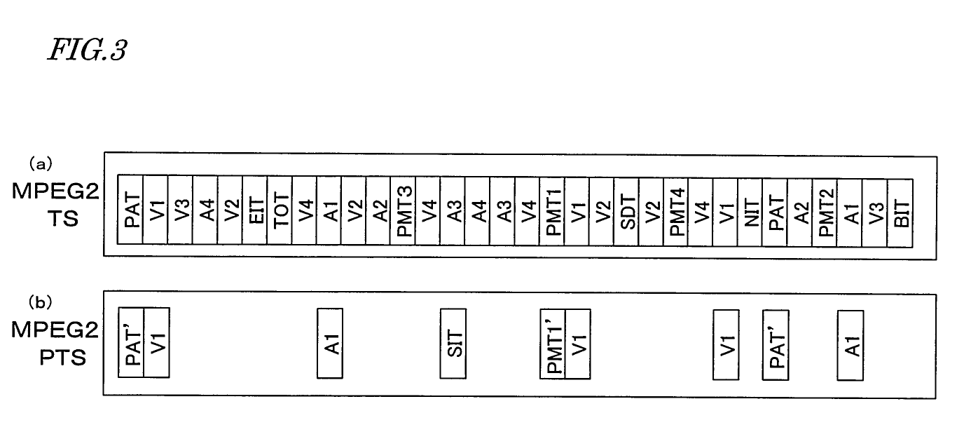

FIG. 3(a) shows the arrangement of packets in the TS received by the MPEG-TS processing section 204 and FIG. 3(b) shows the arrangement of packets in the partial TS that has been output from the MPEG-TS processing section 204. Each box with a label PAT, V1, etc. corresponds to a single TS packet. Vn, An (where n=1 to 4) and so on represent that the video and audio data of a program n are included.

The MPEG-TS processing section 204 extracts not only the video and audio packets V1 and A1 of Program No. 1 but also PAT and PMT1 tables of program association information from the TS shown in FIG. 3(a) and modifies the contents of those tables for the partial TS. As a result, PAT′ and PMT1′ are included in the partial TS. Also stored in the partial TS is a selection information table (SIT), including only the information concerning a selected program, in place of the service information (SI) and program specific information (PSI) that are included in the TS.

TS packets representing a particular program can be extracted from the TS by performing the following processing. For example, TS packets representing Program No. 1 may be extracted in the following manner. Suppose the program number (or channel number) of Program No. 1 is X. In that case, first, the TS packets are searched for the program association table (PAT) packet. More specifically, a packet ID (PID) is assigned to each TS packet. The PID of the program association table packet may be zero, for example. Then, the TS may be searched for a packet having that value.

In the program association table in the program association table packet, respective program numbers and the program map table (PMT) packet IDs of respective programs associated with those program numbers are stored. Thus, the packet ID (PID) of the program map table (PMT) associated with the program number X can be detected. The PID of the program map table PMT is supposed to be XX.

Next, when a packet with PID=XX is extracted, a program map table associated with the program number X can be obtained. The program map table PMT includes the PIDs of TS packets, in which the video, audio and other information of each program to watch and listen to is stored. For example, the PID of the video information associated with the program number X may be XV and the PID of the audio information thereof may be XA. By using the PID (=XV) of the packet storing the video information and the PID (=XA) of the packet storing the audio information, the video and audio packets about a particular program content can be extracted from a single TS.

In making a partial TS from a TS, the program association table PAT and program map table PMT need to be corrected. This is because the original TS and the partial TS include different numbers of programs, and therefore, the program association table PAT and the program map table PMT need to be adapted to the partial TS. Also, the original TS includes SI packets. An SI packet includes data describing the contents, schedule/timings and so on of the programs included in the original TS and separately defined expansion information (which is also called “program service information”). In the original TS, the SI packet includes as many as 20 to 30 different types of data. Among these types of data, only important data for playing the partial TS is extracted to generate a single SIT packet and multiplex it in the partial TS.

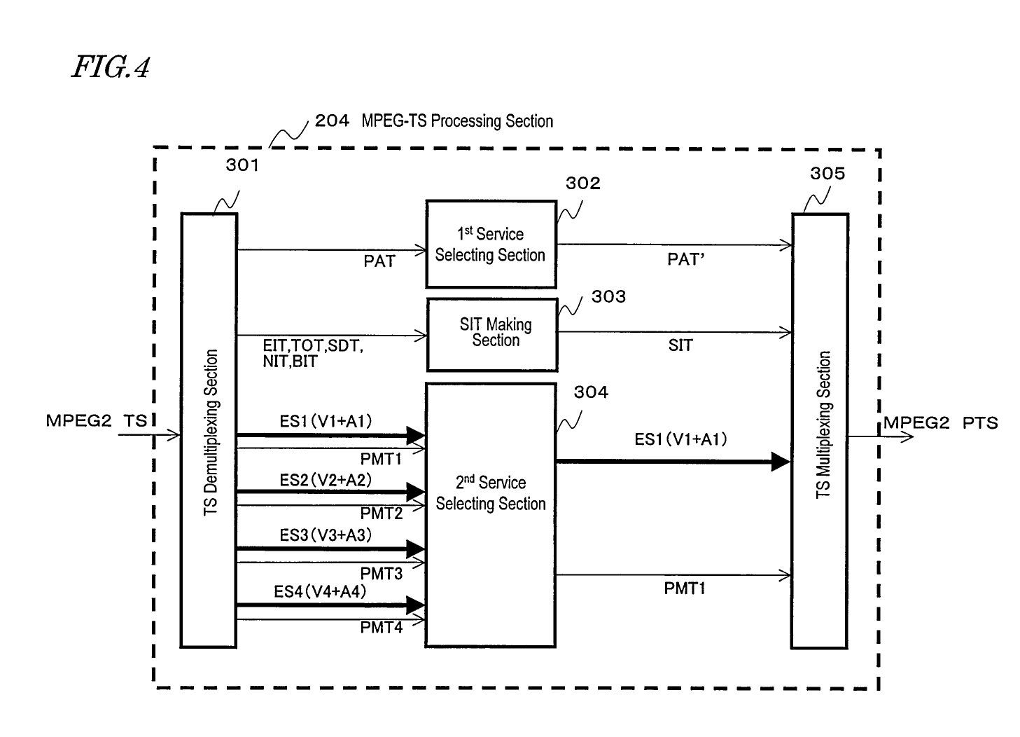

FIG. 4 shows an arrangement of functional blocks in the MPEG-TS processing section 204. The MPEG-TS processing section 204 generates a partial TS from the TS by using the components shown in FIG. 4. It should be noted that the TS and the partial TS are just as shown in FIGS. 3(a) and 3(b), respectively.

The MPEG-TS processing section 204 includes a TS demultiplexing section 301, a first service selecting section 302, an SIT making section 303, a second service selecting section 304, and a TS multiplexing section 305.

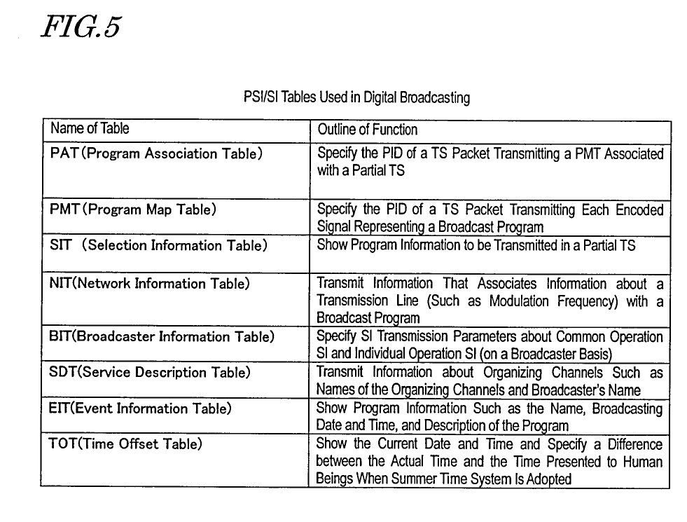

On receiving a TS in which four contents have been multiplexed together, the TS demultiplexing section 301 demultiplexes the TS into its elements including service information (SI), program specific information (PSI), and elementary stream (ES). The service information (SI) and program specific information (PSI) are generic terms of the structure (called a “table”) shown in FIG. 5, which lists the service information (SI) and program specific information (PSI) that are used in a TS. These tables are published as an Association of Radio Industries and Businesses (ARIB) standard. In each of these tables, respective pieces of information are arranged in a predefined order. Elementary streams ES are defined for the video data and audio data of each program. For example, the elementary stream ES concerning the video of program n is separately stored in TS packets Vn. In FIG. 4, the video and audio elementary streams of the program n are collectively identified by ESn for convenience sake.

The first service selecting section 302 extracts a portion, specifying the PID of a TS packet that transmits the program map table PMT associated with the partial TS of a designated program, from the program association table PAT, in which multiple sets of program information are stored, thereby generating PAT′.

The SIT making section 303 extracts only a portion defining the service information and program specific information about a designated program from the tables representing the service information (SI) and program specific information (PSI) of multiple programs included in the TS, thereby newly compiling a selection information table SIT.

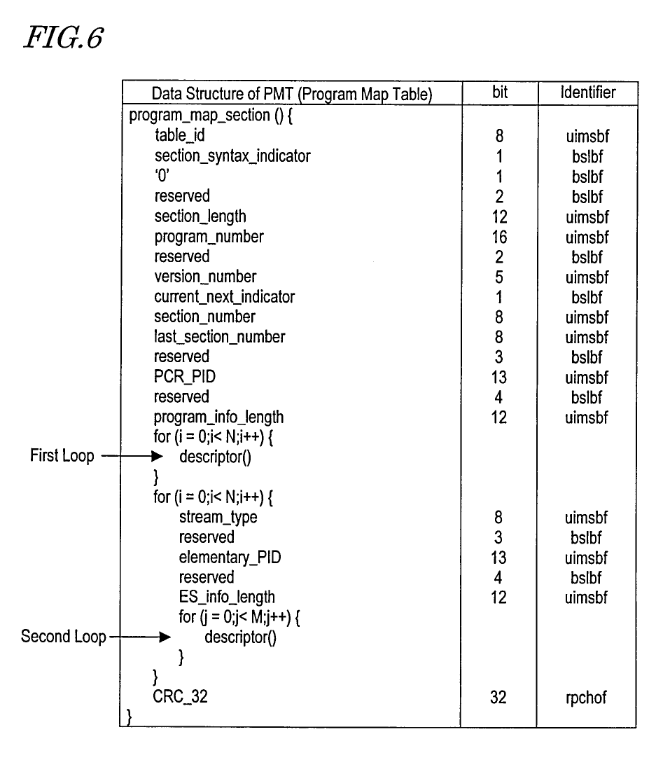

The second service selecting section 304 selectively gets only the ES of the designated program from the ES of respective programs that have been separated by the TS demultiplexing section 301. The second service selecting section 304 also gets a program map table PMT associated with the ES acquired and then outputs not only the ES acquired but also the program map table PMT, from which the portion specifying the PID of the packet where the ES divided data is stored has been extracted. In FIG. 4, for example, the second service selecting section 304 outputs ES1 (including V1 and A1) about Program No. 1 and PMT1 associated with that ES1. Optionally, the second service selecting section 304 may also store the copyright control information (to be described later) on the program map table PMT and then output the program map table PMT. The program map table PMT of the present invention will be described in detail later with reference to FIG. 6.

The TS multiplexing section 305 multiplexes together the program association table PAT′, selection information table SIT, elementary stream ES and program map table PMT of the designated program, thereby making a partial TS.

In this manner, an MPEG2-PTS, including only the information of a particular program, is reconstructed from an MPEG2-TS including the information of multiple programs.

The MPEG2-PTS that has been reconstructed by the MPEG-TS processing section 204 is input to, and converted into an MPEG2-PS, by the TS-PS converting section 205. Also, the MPEG2-PTS is input to, and converted into an MPEG-4 stream by, the MPEG 2-4 converting section 206. Both the conversion processing between the TS and PS formats and the conversion processing between the MPEG-2 and MPEG-4 formats are well known in the art, and the description thereof will be omitted herein.

Next, it will be described how the management information generating section 203 generates management information. The following description will be focused on the processing of generating information about copyright protection, which is one of various types of management information.

The management information generating section 203 also receives an MPEG2-TS. As described above, the service information (SI) and program specific information (PSI) shown in FIG. 5 are included in the MPEG2-TS. The standard permits the service information (SI) and program specific information (PSI) to store an arbitrary number of structures called “descriptors” at particular locations. FIG. 6 shows an exemplary data structure of a program map table PMT. The main purpose of the program map table PMT is to specify the packet IDs (PIDs) of TS packets that transmit the respective encoded signals forming a broadcast program. In the program map table PMT, arbitrary descriptors may be inserted into locations that are called “first loop” and “second loop”, respectively.

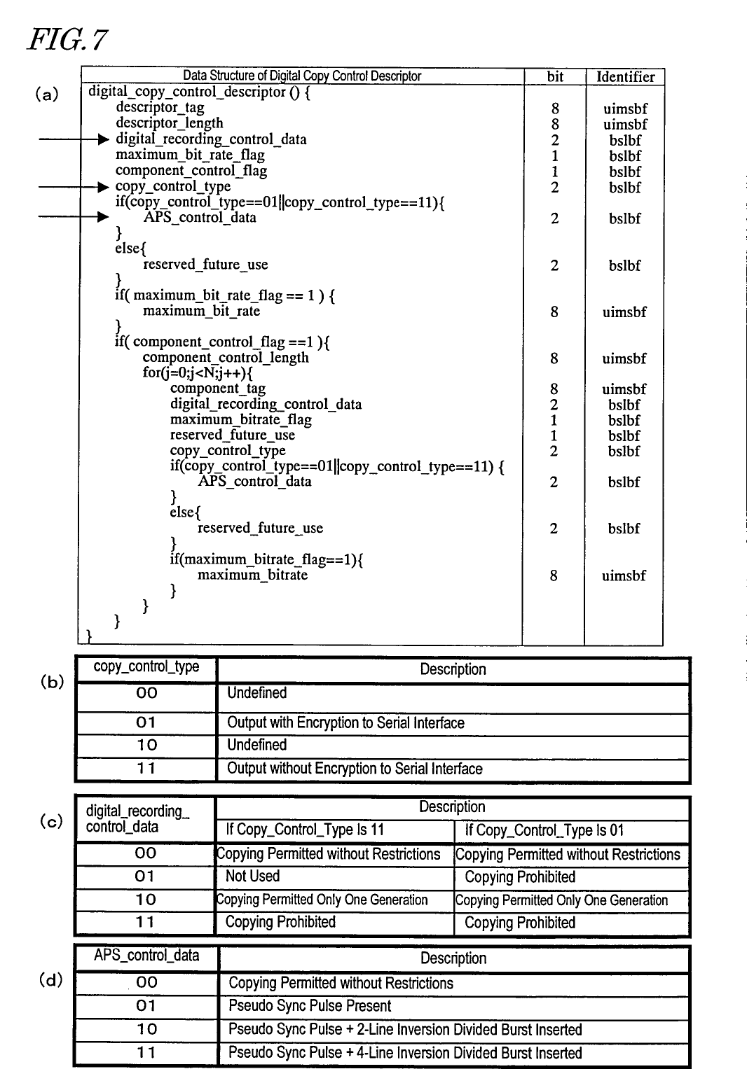

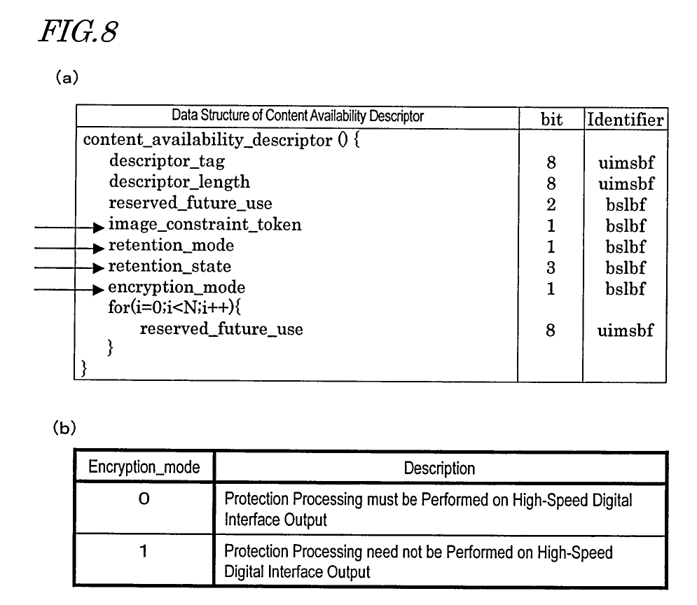

Examples of descriptors insertable into these locations include a digital copy control descriptor and a content availability descriptor, each of which is a descriptor contributing to copyright protection in digital broadcasting. Hereinafter, the data structures of these two descriptors will be described with reference to FIGS. 7 and 8.

FIG. 7(a) shows the data structure of a digital copy control descriptor. The digital copy control descriptor is provided to define control information about digital copying or analog copying or to describe a maximum transfer rate for the overall service or an individual elementary stream.

In the two fields digital_recording_control_data and copy_control_type of the digital copy control descriptor, copyright protection information is described as pointed by the upper two arrows in FIG. 7(a).

The copy_control_type field has a two-bit value representing information about the form of copy generation control. FIG. 7(b) shows correspondence between a two-bit value described in the copy_control_type field and the operation of the information storage device 100 associated with that value. For example, if the value in the copy_control_type field is “01”, then the information storage device 100 encrypts given content data and then outputs the encrypted data to the serial interface (through the IEEE 1394 bus). On the other hand, if the value in the copy_control_type field is “11”, then the information storage device 100 outputs the content data to the serial interface without encrypting it.

The digital_recording_control_data field includes information about the copy generation control. The operations associated with the values in this field are defined so as to apply to the situation where the value in the copy_control_type field is “11” or “01” (i.e., where the content data is output through the IEEE 1394 bus). FIG. 7(c) shows correspondence between a two-bit value described in the digital_recording_control_data field and the operation of the information storage device 100 associated with that value.

Furthermore, in the APS_control_data field pointed by the third uppermost arrow in FIG. 7(a), information for controlling an analog protection system that can be added to an analog video signal is described. FIG. 7(d) shows correspondence between a two-bit value described in the APS_control_data field and the operation of the information storage device 100 associated with that value. As used herein, the “analog protection system” may mean a “Macrovision signal” and is known as an analog copy control signal (which is called an “AGC (automatic gain control)” or “Corol Stripes”) licensed by Macrovision Corporation. Specifically, unless the value in the digital_recording_control_data field is “11” and unless the value in the APS_control_data field is “00”, the Macrovision signal is added. Some storage media can inherit the APS_control_data field. For example, a content, of which the digital_recording_control_data field has a value “10”, may be recorded as “no copying permitted anymore”. And when the “no copying permitted anymore” content is played back, the Macrovision signal may be added to the analog video output according to the value in the APS_control_data field inherited by the storage medium. If the value in the copy_control_type field is “01”, then the content is encrypted and output to the serial interface according to predetermined operation rules.

Next, the content availability descriptor will be described with reference to FIGS. 8(a) and 8(b).

FIG. 8(a) shows the data structure of the content availability descriptor. The content availability descriptor is defined to describe control information about the bound recording of data on a medium and the output thereof with respect to a program. Among various fields described as the content availability descriptor, the resolution constraint bit (image_constraint_token) as pointed by the first arrow shows whether or not a constraint needs to be imposed on the resolution of a video signal output. If the bit value is “0”, then a constraint must be imposed on the resolution. On the other hand, if the bit value is “1”, then no constraint needs to be imposed on the resolution. For example, in digital broadcasting within Japan, the use of the resolution constraint bit is prohibited, and therefore, the image_constraint_token is always set to “1”.

The temporary bound recording control bit (retention_mode) of the content availability descriptor as pointed by the second arrow indicates whether or not temporary bound recording is permitted. If the bit value is “0”, temporary bound recording is permitted even if the digital_recording_control_data of the digital copy control descriptor shows “copy never”. On the other hand, if the bit value is “1”, no temporary bound recording is permitted.

The permissible temporary bound recording duration (retention_state) of the content availability descriptor as pointed by the third arrow shows how long a content can be temporarily bound-recorded since its reception. In digital broadcasting within Japan, for example, the temporary bound recording bit (retention_mode) and the permissible temporary bound recording duration (retention_state) are used so as to be always fixed at “0” and “111” (i.e., the permissible temporary bound recording duration is 90 minutes), respectively.

In the encryption_mode field of the content availability descriptor as pointed by the fourth arrow, copyright protection information is described as a one-bit value. More specifically, the encryption_mode field is used to protect the output through a high-speed digital interface (such as an IEEE 1394 bus).

FIG. 8(b) shows the details of processing to be done according to the bit value in the encryption_mode field. Specifically, in order to deter copyright infringement of a content by its re-transmission over the Internet, the encryption_mode field is provided to get a content encryption-recorded and to permit its playback with only a particular player. In this case, duplication for private use and fair use are permitted and no restrictions are put on the number of copies that can be made or copy generations. This is called Encryption Plus Non-Assertion (EPN). The “EPN” indicates that a content may be copied without restrictions but must be encryption recorded.

It should be noted that the digital copy control descriptor and content availability descriptor may be described not just in the program map table PMT but also in a service description table (SDT) or in an event information table (EIT).

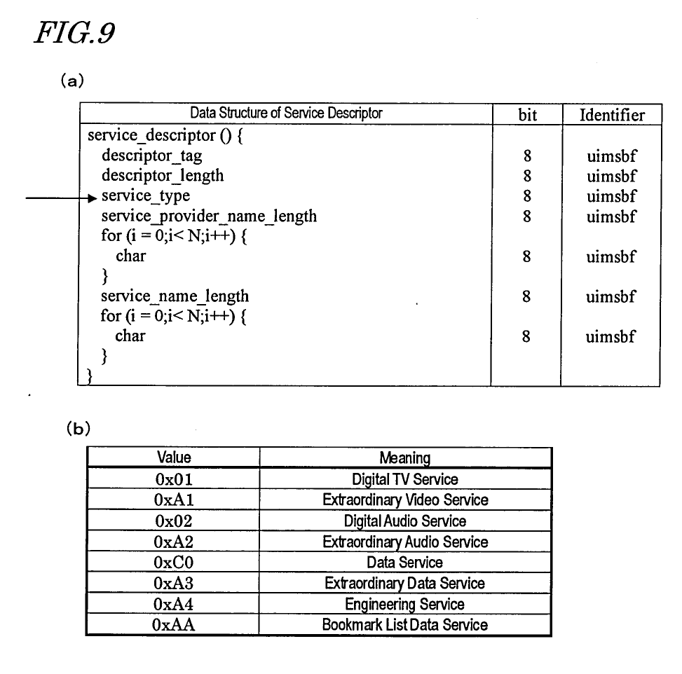

FIG. 9(a) shows the data structure of a service descriptor. The service descriptor is a parameter defined in the service description table (SDT) mentioned above and describes a parameter showing the source of the input signal. This parameter is called a “service type”. In the digital broadcasting, for example, a digital TV service providing digital video contents, a digital audio service providing digital audio contents, a data service providing data contents such as character information and other service types are defined. The service type is described in the service_type field of the service descriptor. In FIG. 9(a), the service_type field is pointed to by the arrow. FIG. 9(b) shows correspondence between a possible value in the service_type field and its associated service. The copyright protection is defined slightly differently according to the service type, but the specific difference will be described later.

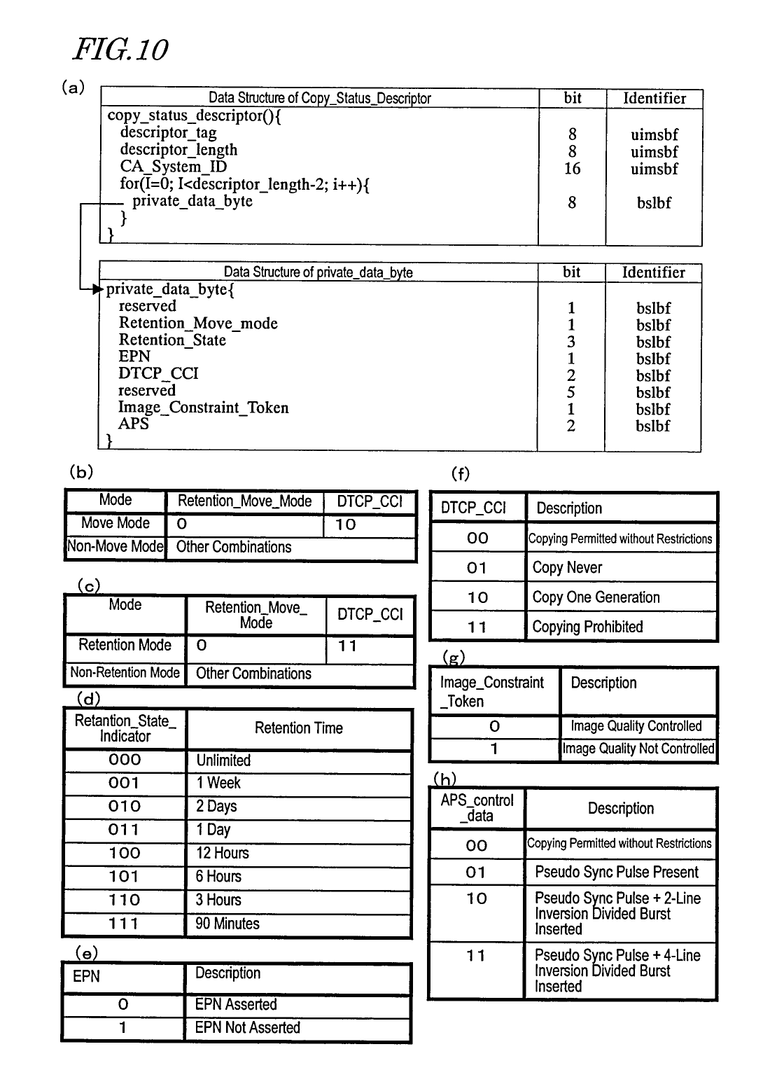

The management information generating section 203 generates the management information about copyright protection. Such management information is included as a copy status descriptor in the partial TS. FIG. 10(a) shows the data structure of a copy status descriptor. The copy status descriptor is identical with DTCP_descriptor defined by the Digital Transmission Content Protection (DTCP), which is a technique of protecting a content to be transmitted through an IEEE 1394 bus, for example. The respective fields of the copy status descriptor are defined as shown in FIGS. 10(b) through 10(h) and the values are determined based on the settings of the digital copy control descriptor and content availability descriptor.

Referring back to FIG. 2, the copy status descriptor in the partial TS is sent to the management information generating section 203 and inserted by the management information generating section 203 into the first loop of the PMT (see FIG. 6). If any special copyright protection information is allocated to one of the elementary streams that form a content, then the management information generating section 203 also inserts a copy status descriptor into the second loop (see FIG. 6) associated with the elementary stream.

The management information generating section 203 always analyzes the incoming MPEG2-TS. If the copyright information has changed, then the management information generating section 203 generates a new copy status descriptor and sends it to the MPEG2-TS processing section 204. That is why depending on how the user is performing a recording control on the content, the copyright information may change within the same content. For example, if two programs (e.g., a news program and a soap opera) have been broadcast continuously and recorded as a single content and if the news program is “copying permitted without restrictions” and the soap opera is “copy one generation”, then the DTCP_CCI value changes somewhere in the single content.

Also, the management information may be bound-recorded in a unique format in the management information files of the bound recording section 105. This is because the management information will be needed to bound-record a content or control the content by copying or moving it onto a removable storage medium as will be described later. It should be noted that if the copyright protection information has been altered, then the content could be used illegally. To deter such illegal use, various measures, including encryption, addition of a check code to detect the alteration, and recording the content in an area that is not accessible for users, are taken.

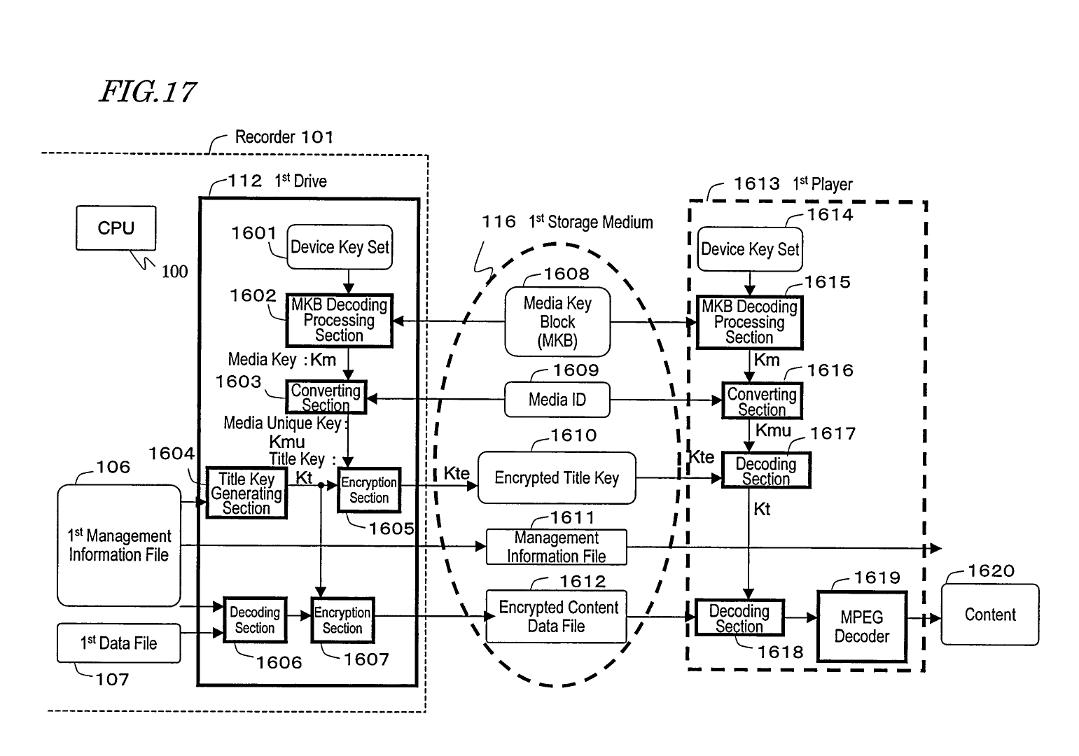

Next, the configuration and operation of the encryption processing section 104 will be described in detail. The encryption processing section 104 encrypts the content's data that has been supplied from the receiving section 103 (such as the MPEG2-PTS, MPEG2-PS or MPEG-4 stream) according to the specifications of the bound recording section 105 and the first, second and third storage media 116, 118 and 119. In this preferred embodiment, the content is supposed to be moved to the DVD-RAM or the SD memory card. Therefore, the encryption processing section 104 performs the encryption in accordance with the key management and encryption methods that are defined by the CPRM, which is a technique of protecting the contents of these storage media. The encryption processing done by the encryption processing section 104 is the same as that performed by the first drive 112 using the title key Kt as will be described later with reference to FIG. 17.

Suppose a digital broadcast content is bound-recorded or recorded on a removable storage medium. A content, of which the copy is controlled by the digital_recording_control_data of the digital copy control descriptor, and a content, which should be protected according to the encryption_mode of the content availability descriptor, need to be protected by encryption. As the cryptography, an encryption algorithm with an intensity that is equal to or higher than that of a common key code with a key data length of 56 bits and with a sufficient degree of security (e.g., C2 (Cryptomeria Cipher), AES (Advanced Encryption Standard) or DES (Data Encryption Standard)) is used. The C2 code is used in the CPRM.

FIG. 11 shows an arrangement of functional blocks in the encryption processing section 104. The encryption processing section 104 includes a title key generating section 501 and an encryption section 502.

The title key generating section 501 generates a random number of 56 bits and outputs it as a title key Kt for encrypting each content. The encryption section 502 converts the title key Kt by Analog Protection System (APS), which forms a part of copyright protection information. By associating the APS with the title key Kt, if the APS value were altered on the storage medium, then the correct cryptographic key could not be obtained during playback and the encrypted content could not be decrypted. As a result, the illegal use can be deterred. The encryption section 502 uses a converted title key Kt as a key for encrypting the content. Also, the encryption section 502 encrypts a content that has been packed into audio and video packs (which are called “AV packs” collectively) on a 2,048 byte basis. In this case, a portion of the AV packs is associated with the title key that has been converted by the APS, thereby changing the keys on an AV pack basis. The C2 code is used as the code.

In the example shown in FIG. 11, the encryption section 104 uses the CPRM as a method of protecting the storage medium. However, if the storage medium adopts a different protection method, then the configuration of the encryption section 104 just needs to be changed according to the protection method.

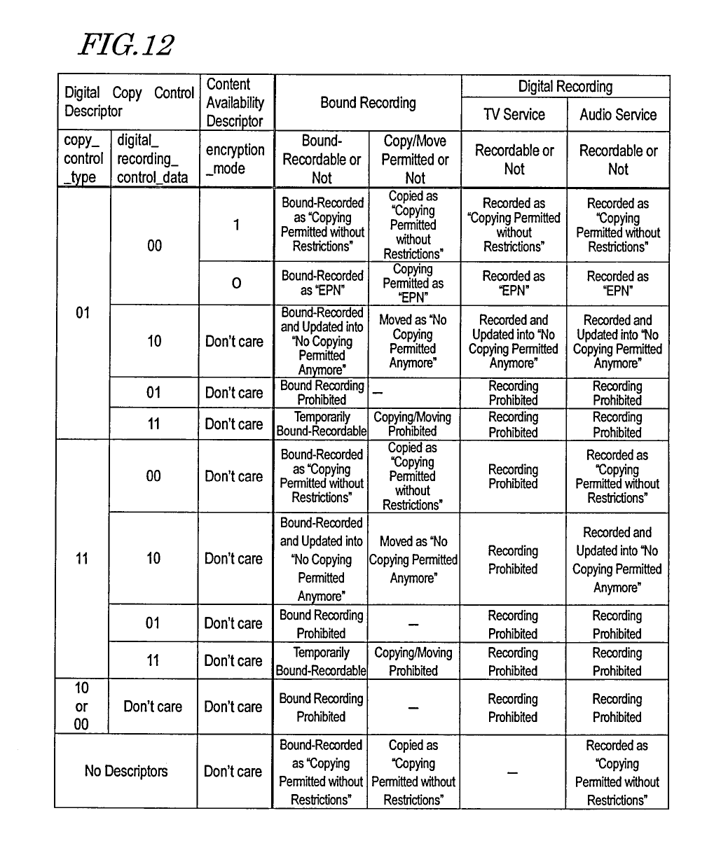

The bound recording section 105 bound-records a content and its management information. It is in accordance with the copyright information of a given content whether or not the content may be bound-recorded and how the content should be bound-recorded. FIG. 12 shows how the copyright protection information defines the bound recording operation and the operation of recording a content on a removable storage medium.

As to bound-recording a content, if the digital_recording_control_data of the digital copy control descriptor is “00” indicating “copying permitted without restrictions”, the content can be bound-recorded without restrictions. And the content that has been supplied from the receiving section 103 is bound-recorded without being encrypted.

On the other hand, if the digital_recording_control_data of the digital copy control descriptor is “10” indicating “copying permitted only one generation (copy one generation)”, the copy control information on the bound recording medium is bound-recorded as “no copying permitted anymore (copy never)”. In that case, the encryption processing section 104 bound-records an encrypted content. The content that is bound-recorded as “copy never” may not be copied to a storage medium but can be moved.

Move can be made only to a single built-in storage medium or a single digitally connected storage medium. If a move is made to another storage medium that is connected over a high-speed digital interface (such as IEEE 1394 bus), the DTCP rules need to be followed. If the number of connectable storage media is indefinite (or uncertain) for an output such as an analog video output, no move can be made. Also, no content with a duration exceeding one minute should be playable at both the source of the content on the move and the destination thereof at the same time during the move processing. Furthermore, after the move has been made, the content should not be available at both the source and destination thereof at the same time. That is to say, when the move is completed, the content at the source is made non-playable. These methods of realization of this preferred embodiment will be described more fully later.

If the digital_recording_control_data of the digital copy control descriptor is “11” meaning “copy never”, no bound recording but temporary bound recording is permitted. In other words, the content that has been encrypted by the encryption processing section 104 may be bound-recorded temporarily until the permissible temporary bound recording duration passes. If the temporary bound recording duration has exceeded its permissible duration, the content is made non-playable within one minute after the permissible temporary bound recording duration has passed. A clock for use in the management of temporary bound recording duration has appropriate time accuracy and is not accessible for users. If a temporarily bound-recorded content needs to be read and output, the content is output after having been subjected to “copy never” processing. In the high-speed digital interface (IEEE 1394), the content is output after having been subjected to Non-Retention-mode processing defined by the DTCP.

### D. CORRELATION BETWEEN MANAGEMENT INFORMATION FILES AND DATA FILES THAT ARE BOUND-RECORDED IN BOUND RECORDING SECTION

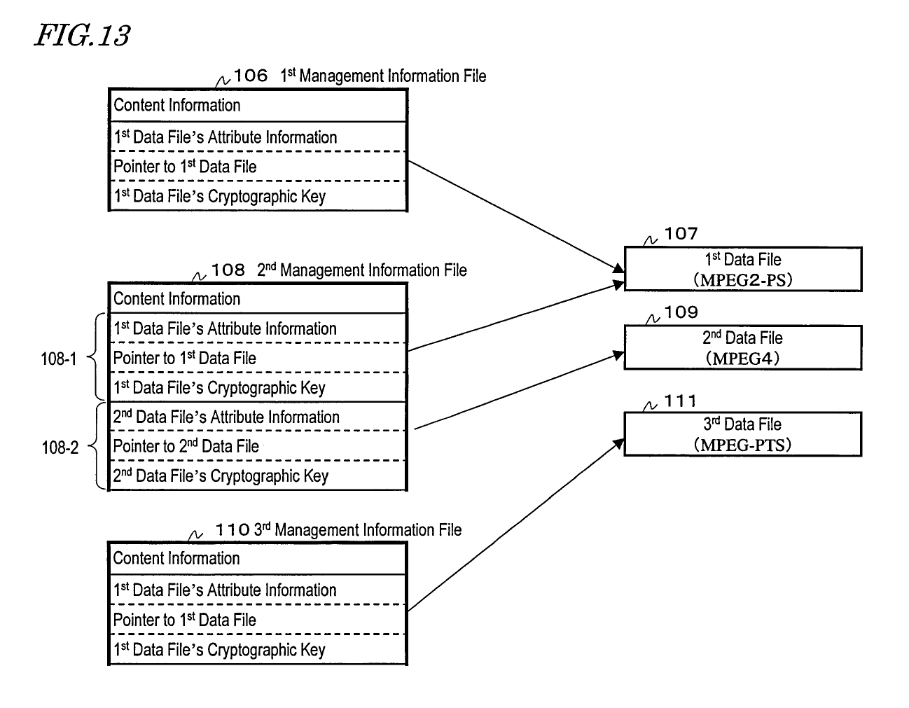

Following these rules, the bound recording section 105 bound-records the management information and data files on a content-by-content basis. FIG. 13 shows at least one content that is bound-recorded in the bound recording section 105 and the management information associated with each content. If the bound recording section 105 bound-records a plurality of contents, then the management information and data files shown in FIG. 13 are generated for each of those contents.

Each of the data files 107, 109 and 111 stores the data of either the non-encrypted content supplied from the receiving section 103 or the encrypted content supplied from the encryption processing section 104. In this example, the content is supposed to have been broadcast as “copy one generation” and then encrypted and bound-recorded as “copy never” in the bound recording section 105. Also, the data streams of a single content are supposed to be generated in three different types of formats. To generate multiple types of data streams as first-generation copies is not contrary to the “copy one generation” restriction. It should be noted, however, that if respective data streams are generated as first-generation copies and then another type of data streams are generated from the former data streams, then it means making second-generation copies, which is prohibited by this restriction.

The first data file 107 is a file obtained by encrypting an MPEG-2 program stream. The second data file 109 is a file obtained by encrypting an MPEG-4 stream. And the third data file 111 is a file obtained by encrypting an MPEG2-PTS. The number of management information files is equal to or less than three (which is equal to the maximum number of copies that can be made) for each content. The maximum number of copies that can be made is either set by the content's provider or determined in advance for each content distribution system.

Next, the management information files 106, 108 and 110 will be described one by one.

The first management information file 106 is defined so as to move the first data file 107 to a DVD-RAM. The first management information file 106 includes content information, first data file's attribute information, first data file's pointer, and first data file's cryptographic key.

The content information includes content attribute information such as the title, on-air date and time, duration, broadcaster's name, category, cast, keyword, and copyright protection information of a given content and user's memos. As the copyright protection information, information that designates a storage medium to which the content may be moved (e.g., the type of the destination storage medium) or the drive number of that storage medium may be stored. Examples of the types of destination storage media include DVD-RAM, DVD-RW and DVD-R.

The type of the destination storage medium is defined as a piece of copyright protection information. This is because when there are a number of management information files, their associated stream files could be moved to the same type of storage media. That is to say, if there are multiple management information files as shown in FIG. 13, then their associated stream files could be moved to the same type of storage media in accordance with their management information. As a result, the same content might be moved to the same type of storage media one after another. For example, the same content could be moved to multiple DVD-R's. However, such a situation needs to be avoided. This is because normally there is not so much need to make copies of a copyrighted work on the same type of storage media a number of times if the copies are supposed to be used privately. Multiple copies might rather encourage infringement because if one of those copies were given to another person, then its copyright would be infringed. That is why by preventing the user from designating the same type of storage media more than once by utilizing the information that designates the destination storage medium, such infringement can be discouraged.

It should be noted that if the information about the type of the destination storage medium were altered by removing the bound recording medium from the recorder 101 and connecting it to a personal computer, for example, then the copyright protection would lose its validity. For that reason, the type of the destination storage medium needs to be stored by either a method that can prevent such alteration or a method that can detect such alteration. For example, if a cryptographic key and an encryption processing code are stored on the CPU 100 and if the information about the type of the storage medium is encrypted so as to be decrypted only by the CPU 100, then it will be difficult to alter the information. In another example, when the content is stored, the hash value (or check code) of the overall information about the type of the destination storage medium may be calculated by using the key information that is retained on the CPU 100 and may be added to the information about the type of the storage medium. When the content is used, the hash value may be calculated again. And the alteration, if any, can be detected by determining whether or not the two hash values agree with each other.

Examples of the attribute information of the first data file 106 include information that shows the codec type (such as MPEG-PS), video signal type (such as NTSC or PAL), number of scan lines, bit rate (or video recording mode indicated as high quality, standard quality, long play, or super long play), file size and audio mode (such as monaural, stereo and 5.1 ch) of the data file.

As a pointer to the first data file, the access information for the first data file (MPEG2-PS) is stored. As used herein, the “access information” is information to identify and read the first data file. For example, the access information may be information about the locations of the top and end of the data file. More specifically, the storage address and file name of the first data file that is stored in the bound recording section 105 are examples of the access information. The storage address includes the top and end addresses of the first data file or the top address and file size thereof. Also, if the file name is adopted as access information, then the storage location of the file may be detected by the file system used. Alternatively, a table of correspondence between the names and storage locations of files may be compiled and the storage location of the file may be found by reference to that table.

The cryptographic key of the first data file is the title key that was used by the encryption processing section 104 to encrypt the content. Even if erased once, the first data file's pointer, which is stored as management information, could be restored easily by analyzing the disk using a PC, for example. That is why the pointer alone cannot guarantee content protection. As to a cryptographic key on the other hand, it is difficult to restore the cryptographic key that has been erased once. Thus, the cryptographic key guarantees content protection. To prevent the user from using the content illegally even if the bound recording section 106 were removed from the recorder 101, the title key and copyright protection information are encrypted with a device unique key, which is stored elsewhere, not in the bound recording section 106. To prevent leakage, the device unique key may be stored inside an encryption processing LSI or retained in a memory that cannot be accessed externally. Alternatively, the device unique key may also be encrypted by the LSI's unique method and stored outside of the LSI. As another alternative, the title key and copyright protection information may be stored in a storage area that is not accessible for users, e.g., non-user-accessible storage (not shown) that is provided separately from the bound recording section 106. There is no problem if the copyright protection information is just read. That is why the copyright protection information does not have to be encrypted but may be just provided with a check code for use to detect the alteration. And if the alteration of the copyright protection information is detected when the content is used, then the use of the content may be either prohibited totally or permitted only under the strictest copyright protected state. By using such information that is difficult to alter or requires a particular operation upon the detection of alteration (e.g., cryptographic key, title key and copyright protection information), the availability of the content's data can be controlled.

The second management information file 108 is defined so as to move a content to an SD memory card. The second management information file 108 includes content information, a set of management information 108-1 about the first data file, and a set of management information 108-2 about the second data file.

The content information includes the title of the content, for example, and is similar to that of the first management information file 106. In this case, however, the content information may include the type of the destination storage medium (i.e., “SD memory card” in this example).

The set of management information 108-1 is defined for the first data file 107 and includes the attribute information, pointer and cryptographic key of the first data file. These pieces of information are similar to those stored in the first management information file 106. The other set of management information 108-2 is defined for the second data file 109 and also includes the attribute information, pointer and cryptographic key of the second data file. Although these two sets of management information 108-1 and 108-2 are included in the second management information file 108, their object is the same content. That is why not more than a single piece of content information is necessary.

The second management information file 108 includes the two sets of management information 108-1 and 108-2. This is because the SD memory card as the destination storage medium is compatible with both an MPEG2-PS and an MPEG-4 stream (i.e., can record the content in any of these two formats) and needs two sets of management information for the two different formats.

The third management information file 110 is defined so as to move a content to a D-VHS. The third management information file 110 includes content information and the attribute information, pointer and cryptographic key of the third data file.

In playing back a content, the user needs to select one of these three management information files and give an instruction to start playback by using the user interface section 115. In response, the recorder 101 reads the data file associated with the management information file selected and plays back the content based on the data file.

In the example shown in FIG. 13, three data files are provided. However, the number of data files provided may be either greater or smaller than three. The types of the streams do not have to be different from each other. As for an MPEG2-PS to be recorded on a DVD-RAM, for example, multiple data files may be prepared and bound-recorded according to various criteria including high quality preferred, standard accepted, long play preferred, and long play preferred first and foremost.

Furthermore, if the TS-PS converting section 205 can afford to do such processing, MPEG2-PS files may be generated at multiple bit rates at the same time. Alternatively, the MPEG-PTS that has already been bound-recorded once as the third data file 111 in the bound recording section 105 may be subjected to the TS-PS conversion at a different bit rate from the MPEG2-PS file that is already bound-recorded as a part of a series of bound recording processes. In any case, however, the content and title key are appropriately protected by encryption, for example.

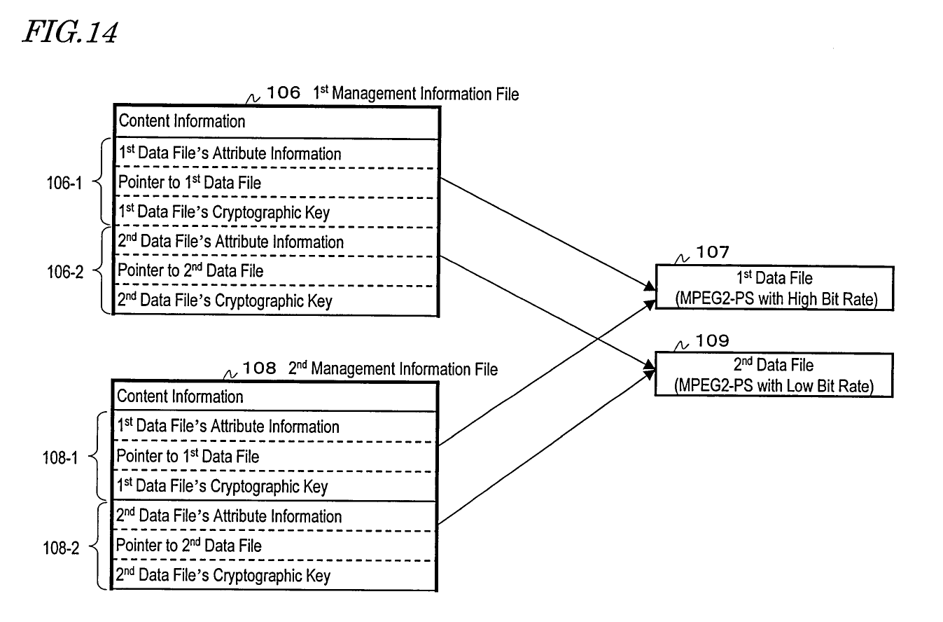

FIG. 14 shows two MPEG2-PS data files 107 and 109 with mutually different bit rates and two management information files 106 and 108. In this example, an MPEG2-PS is supposed to be stored in the first data file 107 at a relatively high bit rate (e.g., 10 Mbps), while an MPEG2-PS is supposed to be stored in the second data file 109 at a relatively low bit rate (e.g., 2 Mbps).

Each of the management information files 106 and 108 shown in FIG. 14 includes a set of management information for the first data file 107 and a set of management information for the second data file 109. The first management information file 106 is defined so as to move a content to a DVD-RAM, a DVD-RW or a DVD-R. On the other hand, the second management information file 108 is defined so as to move a content to an SD memory card. The first management information file 106 includes a set of management information 106-1 for the first data file 107 and a set of management information 106-2 for the second data file 109. Likewise, the second management information file 108 includes a set of management information 108-1 for the first data file 107 and a set of management information 108-2 for the second data file 109.

It can be seen that if the management information is arranged as shown in FIG. 14, respective groups of management information may be defined for multiple data stream files with different bit rates and may be stored in parallel with each other in the management information file even though the same content is concerned. By associating multiple management information files with multiple data files in this manner, the device can be used in various manners.

In the examples shown in FIGS. 13 and 14, the management information files and data files are provided in various manners. For example, referring to FIG. 13, if attention is paid to only the first management information file 106 and the first data file 107, then the management information file and first data file can be regarded as having a one-to-one relationship. However, if attention is also paid to the third management information file 110 and third data file 111, then there are multiple one-to-one relationships. Meanwhile, if attention is paid to the second management information file 108 and data files 107 and 109, then the management information and data files may be regarded as having a one-to-multi relationship. Furthermore, if attention is paid to the first and second management information files 106 and 108 and data file 107, then the management information and data file can be regarded as having a multi-to-one relationship. And referring to FIG. 14, the management information files 106 and 108 and data files 107 and 109 can be regarded as a multi-to-multi relationship.

### E. CONTENT MOVE PROCESSING

### E-1. Outline of Move Processing

Hereinafter, it will be described how to carry out move processing after the management information and data files have been bound-recorded in the bound recording section 105.

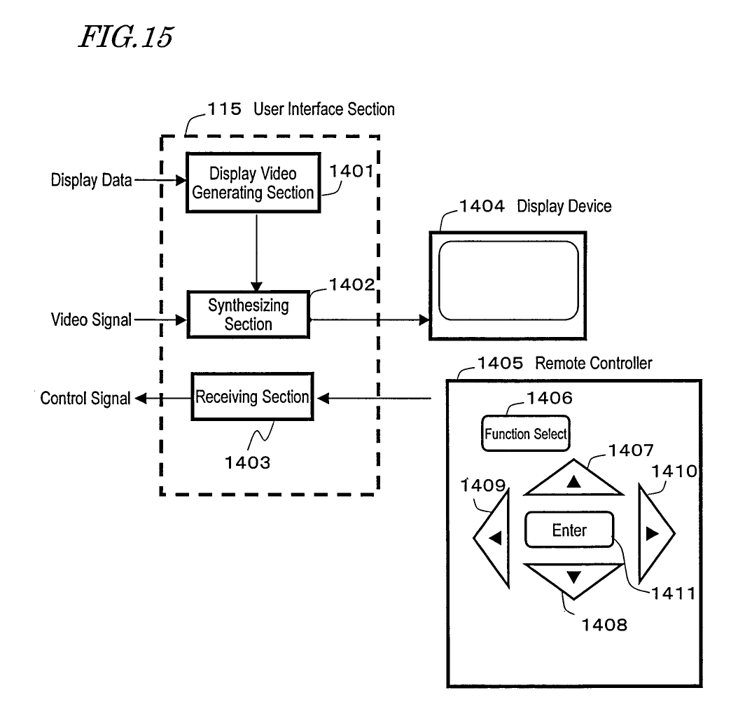

The move processing is started in response to a user's command that has been input through the user interface section 115. FIG. 15 shows an exemplary configuration for the user interface section 115. The user interface section 115 includes a display video generating section 1401, a synthesizing section 1402 and a receiving section 1403.

The display video generating section 1401 generates video to be presented based on the display data that has been supplied from various components of the recorder 101. The synthesizing section 1402 superposes (or switches) the video signal, generated by getting the received or bound-recorded content played back by the recorder 101, on the video presented by the display video generating section 1401, thereby generating a synthesized signal. The synthesized signal is sent to a display device 1404, which is connected as an external device to the recorder 101. The display device 1404 is device for presenting the video signal supplied from the recorder 101 and may be a TV set or a liquid crystal projector, for example. The receiving section 1403 receives a signal from a remote controller 1405 and outputs control signals to respective components of the recorder 101. The remote controller 1405 has keys for controlling the recorder 101 and transmits a control signal as an infrared ray or a radio wave to the recorder 101 in response to the key manipulation. The remote controller 1405 includes at least a function select key 1406, an “up” arrow key 1407, a “down” arrow key 1408, a “left” arrow key 1409, a “right” arrow key 1410, and an enter key 1411 and may include other keys as well.

In the example illustrated in FIG. 15, the display device 1404 and remote controller 1405 are provided separately from the recorder 101. Alternatively, the display device 1404 and remote controller 1405 may be incorporated into the recorder 101. For example, the display device 1404 and remote controller 1405 may be replaced with the liquid crystal display device (not shown) and buttons (not shown, either) of the recorder 101.

The move processing may be carried out in the following procedure. First, the user gets a menu screen shown by pressing the function select key 1406 of the remote controller 1405. Next, the user selects “dubbing” on the menu screen by using the arrow keys, and presses the enter key 1411, thereby getting a dubbing screen shown. “Move” is one of the dubbing (copying) options on the dubbing screen. When the user chooses a content to move on the dubbing screen and determines his or her choice by pushing the enter key, the move processing starts.

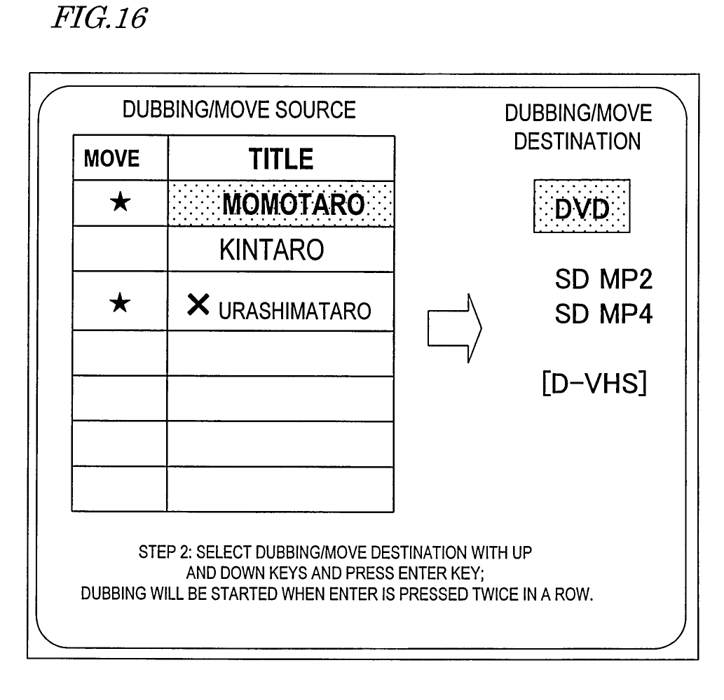

FIG. 16 shows an exemplary image presented on the screen during the move processing. On the right-hand side of the screen, the type of the destination storage medium, to which the content should be dubbed or moved, and the recording format (MP2 or MP4) as for an SD memory card, are presented. The type of the destination storage medium and the recording format that have been selected are stored as pieces of the content information in a management information file. Under the instruction of the CPU 100, the bound recording section 105 reads the content information to get information about the type of the destination storage medium and the recording format. According to this information, the CPU 100 generates display data and sends it to the user interface 105. On receiving the display data, the user interface 105 gets the data presented on the display device 1404. If MP2 format has been selected, an MPEG2-PS is displayed. On the other hand, if MP4 format has been selected, an MPEG-4 stream is displayed. Meanwhile, on the left-hand side of the screen, shown are the titles of contents to be dubbed or moved. And on the left-hand side of any of these titles, the solid stars are displayed to show what contents should be moved. When moved, those contents will be made unavailable by the processing to be described later.

In the example illustrated in FIG. 16, the two contents entitled “Momotaro” and “Urashimataro” will be subjected to the move processing and the other content named “Kintaro” will be subjected to the dubbing processing. Operating instructions are displayed on the bottom of the screen. Every time the user finishes a required operation step by step, the operation to do next is instructed on the screen.

On this dubbing screen, the user selects his or her destination storage medium, to which the content should be dubbed or moved, by tapping the keys. Specifically, by pressing the “up” and “down” keys 1407 and 1408, he or she selects a storage medium. In the example illustrated in FIG. 16, the highlighted portion “DVD” (which is dotted in FIG. 16) is the item currently selected. If the enter key 1411 is pressed in this state, “DVD” is determined as the destination of the dubbing/move processing. When the storage medium is selected in this manner, some of the contents that could be dubbed or copied will get dub- or move-disabled. In the example illustrated in FIG. 16, the content named “Urashimataro” has already been moved to a DVD and its associated management information file is no longer available. That is why “Urashimataro” may not be moved to a DVD again as indicated by the cross “X” attached to the head of the title. Alternatively, such an unavailable content may be shown by “gray-out” (presented in semi-transparent gray) and may even be eliminated from the list.

When the destination of the copy or dubbing processing is selected, the user moves the highlight to the list of contents to dub or move on the left-hand side of the screen by using the “left” arrow key 1409 and chooses a content to be dub or move by using the arrow keys of the remote controller 1405. In the example illustrated in FIG. 16, the dotted title “Momotaro” is currently chosen. If the enter key 1411 is pressed in this state, the choice of “Momotaro” is determined. Meanwhile, as for the content “Urashimataro” that is shown as move-disabled by the cross “X” at the head of the title, even if this content is chosen by tapping the arrow keys, its title is never highlighted but an alert message “this content has already been moved to DVD and is never movable again” is displayed. If the user wants to choose another content in addition to the already picked one, then he or she needs to move the highlight to his or her desired content's title and determine his or her choice with the enter key 1411 pressed. When the content to dub or move is determined in this manner, the recorder 101 checks the available storage capacity of the destination of the dub or move processing. If the remaining storage capacity is less than the data size of the content, then the recorder 101 displays an alert message “DVD's storage capacity is insufficient; replace the DVD with another one or delete unnecessary title from the DVD”. As a result, the choice of the content is prohibited.

If the enter key 1411 is pressed twice back to back, then the recorder 101 displays a confirmation message “move is about to start; press enter key again” on the bottom of the screen. And when the user presses the enter key 1411 again, the CPU 100 starts the processing of moving the selected content “Momotaro” from the bound recording section 105 to the storage medium 116 by way of the user interface section 115.

When the instruction to start the move processing is received, the data file of “Momotaro” that has been bound-recorded in the bound recording section 105 (which is supposed to be the first data file 107) is copied onto the first storage medium by the first drive 112. And the first management information file 106 is made no longer available. Then, a management information file is generated in the first storage medium to complete the move processing.

E-2. Details of Move Processing about First Management information file:

FIG. 17 shows configurations for the first drive 112 of the recorder 101, the first storage medium 116 and the first player 1613. A media key block (MKB) 1608 and a media ID 1609 are stored on the first storage medium 116. The MKB 1608 is data like a “cryptographic key ring” so to speak, which is generated by encrypting a media key Km with all of the device keys issued by a licenser. The MKB 1608 is stored on the first storage medium 116 by a non-alterable method when the storage medium is manufactured. The MKB is produced based on the data that has been figured out with a new media key Km every time a predetermined number of media (e.g., one million as for DVDs) are manufactured. The media ID is data that is uniquely allocated to each storage medium and is stored on the first storage medium 116 by a non-alterable technique when the storage medium is manufactured.

The first drive 112 includes an MKB decoding processing section 1602, a converting section 1603, a title key generating section 1604, an encryption section 1605, a decoding section 1606, and another encryption section 1607. Also, the first drive 112 retains a device key set 1601.

The MKB decoding processing section 1602 generates a media key Km based on the device key set 1601 and the media key block (MKB) 1608. The converting section 1603 converts the media key Km with the media ID 1609, thereby generating a media unique key Kmu. The title key generating section 1604 generates a title key Kt if necessary. The encryption section 1605 encrypts the title key Kt with the media unique key Kmu. The decoding section 1606 decrypts the encrypted first data file 107 if necessary. And the encryption section 1607 encrypts the output of the decoding section 1606 with the title key Kt.

The device key set 1601 in the first drive 112 consists of sixteen device keys and is distributed by a CPRM licenser to drive makers. The combination of keys is changed appropriately by the licenser so that not all of the sixteen device keys distributed to one drive match the counterparts of another. As a licensing condition, the device key set should be embedded in a device so as not to leak. However, if any device key leaked and known to a third party, then it would be possible to make a device or software that can decrypt the encrypted content illegally by using that device key. Thus, to deter such illegal use, MKB data corresponding to the leaked device key is replaced with different data. Then, it is possible to prevent a third party from obtaining a correct media key Km from the leaked device key. That is to say, by using the MKB, the illegal device or software that uses the leaked device key can be invalidated.

The first drive 112 records the encrypted title key 1610, management information file 1611, and encrypted content data file 1612 on the first storage medium 116.

The first player 1613 includes an MKB decoding processing section 1615, a converting section 1616, decoding sections 1617 and 1618, and an MPEG decoder 1619. Also, the first player 1613 retains a device key set 1614. The MKB decoding processing section 1615 generates a media key Km based on the MKB 1608 and device key set 1614. The converting section 1616 converts the media key Km with the media ID 1609, thereby generating a media unique key Kmu. The decoding section 1617 decrypts the encrypted title key 1610 with the media unique key Kmu. The decoding section 1618 decrypts the encrypted content data file 1612 with the title key Kt. And the MPEG decoder 1619 decodes the decrypted content (such as an MPEG2-PS).

In the example illustrated in FIG. 17, the recorder 101 and the first player 1613 are supposed to be two different devices to make their operations understandable more easily. However, a recorder normally has not only a recording function but also a playback function. That is why the recorder 101 and the first player 1613 may have equivalent functional blocks except redundant portions.

Hereinafter, it will be described how to carry out the processing of moving the content, represented by the first data file 107 in the bound recording section 105, to the first storage medium 116.

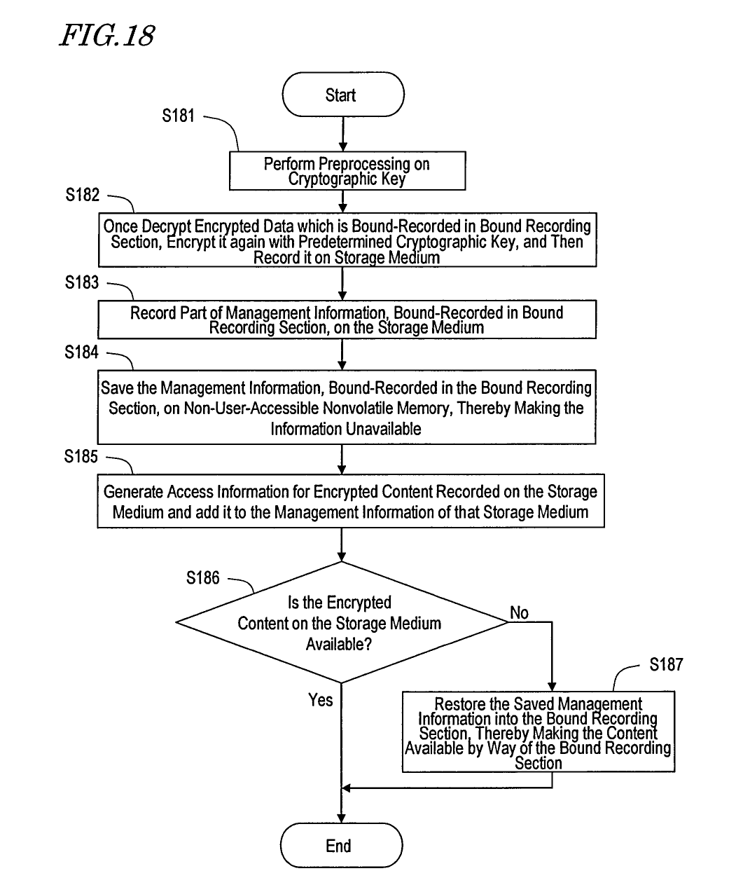

FIG. 18 shows the procedure of content move processing. First, in Step S181, the CPU 100 performs preprocessing on the cryptographic key. As used herein, the “preprocessing” corresponds to the processing of getting the media unique key Kmu generated by the MKB decoding processing section 1602 and converting section 1603 in the first drive 112 shown in FIG. 17, for example. Thereafter, the process advances to Step S182.

In Step S182, the decoding section 1606 once decrypts the encrypted data in the data file that is bound-recorded in the bound recording section 105. Then, the encryption section 1607 encrypts the data again with a predetermined cryptographic key. Thereafter, the first drive 112 records the encrypted data on the destination storage medium. Then, the process advances to Step S183.

In Step S183, the first drive 112 records part of the management information, which is bound-recorded in the bound recording section 105, on the storage medium 116. Next, in Step S184, the CPU 100 saves the management information, which is bound-recorded in the bound recording section 105, on a non-user-accessible nonvolatile memory, thereby making the management information no longer available. Then, in Step S185, access information (or pointer) for the encrypted content that has been recorded on the storage medium 116 is generated and added to the management information of that storage medium.

In Step S186, the CPU 100 determines whether the encrypted content stored on the storage medium 116 is available or not. If the answer is YES, the process ends. Otherwise, the process advances to Step S187. In Step S187, the CPU 100 restores the saved management information into the bound recording section 105, thereby making the content available by way of the bound recording section 105 (i.e., readable from the bound recording section 105 and playable).

The move processing described above can be roughly classified into:
(1) cryptographic key preprocessing;
(2) processing of recording the encrypted content file 1612 on the first storage medium 116 by using the cryptographic key;
(3) processing of making the first management information file 106 in the bound recording section 105 not available; and
(4) processing of recording the access information for the encrypted content file 1612, the encrypted title key 1610, etc. on the first storage medium 116 and making the content readily available.

First, the procedure (1) of cryptographic key preprocessing will be described in more detail. The first drive 112 reads the media key block (MKB) 1608 from the first storage medium 116. The MKB decoding processing section 1602 generates a media key Km based on the MKB 1608 and device key set 1601. The same media key Km is applicable to a lot of storage media. That is why the drive 112 reads the media ID 1609 from the first storage medium 116 and gets the media key converted by the converting section 1603 with the media ID 1609, thereby generating a media unique key Kmu that is uniquely given to each storage medium.

Next, the procedure (2) of recording the encrypted content file 1612 on the first storage medium 116 by using the cryptographic key will be described.

The area of the first storage medium 116 in which the encrypted title key 1610 is recorded has a capacity corresponding to a single item of encrypted title key data. The first drive 112 reads the title key status flag (not shown) of the first storage medium 116, thereby checking whether or not the encrypted title key has been recorded on the first storage medium 116.

If the encrypted title key has not been recorded yet, the following processing steps are carried out. Specifically, the decoding section 1606 reads the encrypted MPEG2-PS data from the first data file 107. The title key that was used to encrypt this file will be recorded later as the encrypted title key 1610 on the first storage medium 116. For that reason, the encrypted MPEG2-PS in the first data file 107 can be recorded as it is in the storage area of the encrypted content data file 1612 of the first storage medium 116. In that case, there is no need to perform the re-encryption process and the content just needs to be read out from the bound recording section 105 and recorded on the first storage medium 116. Consequently, the recording process can be speeded up.

On the other hand, if the encrypted title key has already been recorded on the first storage medium 116, then the following processing steps are carried out. Specifically, the first drive 112 reads the title key status flag (not shown) to sense, by this flag, that the encrypted title key has already been recorded on the first storage medium 116. Thus, the first drive 112 reads the encrypted title key 1610 from the first storage medium 116 and gets the title key Kt retrieved by a decoding section (not shown but having the same configuration as the decoding section 1617 of the first storage medium player 1613) with the media unique key Kmu.

The decoding section 1606 reads the encrypted MPEG2-PS data from the first data file 107. The key that was used to encrypt this file is stored in the first data file's cryptographic key field of the first management information 106. Thus, decrypting is done using this key. The decrypted MPEG2-PS data is encrypted by the encryption section 1607 with the title key Kt that has been generated from the encrypted title key 1610 and then recorded in the area of the storage medium 116 in which the encrypted content data file 1612 has been recorded.

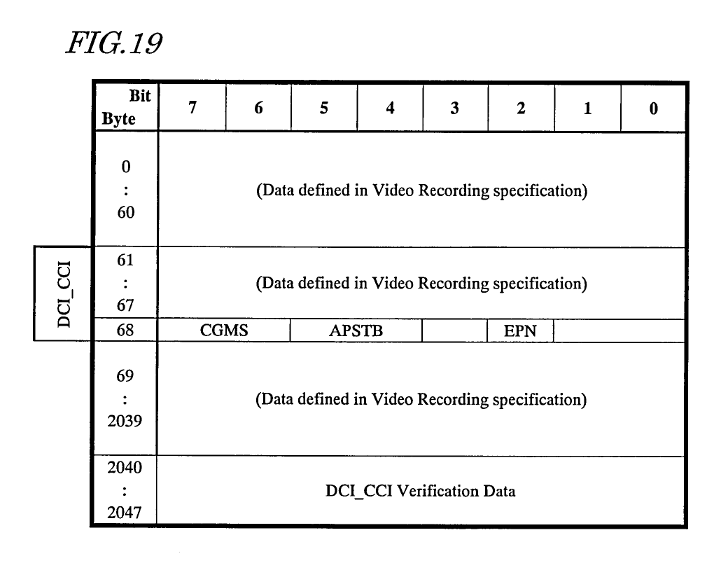

A part of the management information stored in the first management information file 106 is stored in the management information file 1611 of the first storage medium 116. FIG. 19 shows an example of the management information file 1611. The management information file 1611 is called a real-time data information (RDI) pack and has the same size of 2,048 bytes as an AV pack for a content.

In the RDI pack, the copyright information is stored in CGMS, APSTB, and EPN fields. In the CGMS field, stored is digital_recording_control_data. Nevertheless, if the digital_recording_control_data is “copy one generation”, then the data is updated into “copy never” and then stored in the CGMS field. APS_control_data and Encryption_mode (with inverted logic settings) are stored in the APSTB and EPN fields, respectively. The RDI pack is not encrypted but is protected by alteration preventive measures. More specifically, if “copy never” in the CGMS field were altered into “copying permitted without restrictions”, then the player would regard the content as non-encrypted. Thus, the content that has actually been encrypted would be sent to the MPEG decoder 1619 as it is and could not be decoded properly. The APSTB field is used as a part of the cryptographic key by the encryption section 1607. Thus, the correct cryptographic key cannot be obtained from an altered value of the APSTB field during decrypting, which should fail as a result. In the EPN field, check data is stored in the DCI_CCI_Verification_Data field, which can be used to spot alteration.

In this manner, the processing of recording the encrypted content data file 1612 and management information file 1611 on the first storage medium 116 is completed. At this point in time, however, no pointer for the encrypted content data file 1612 has been recorded yet on the first storage medium 116. That is why even if the first storage medium 116 is removed from the recorder 101, the encrypted content data file 1612 still cannot be used.

It should be noted that before the encrypted content data file 1612 on the first storage medium 116 is made available, the processing of making the first management information file 106 in the bound recording section 105 available needs to be carried out. This is because no content with a duration exceeding one minute should be playable at both the source of the content on the move and the destination thereof at the same time.

Thus, the procedure (3) of making the first management information file 106 in the bound recording section 105 not available will be described. To make a management information file not available means disabling the use of a content based on the management information in the management information file and may refer to making the location of its associated data file non-detectable or making the associated data file non-decryptable. For example, to make management information not available may be saving the management information file at a non-user-accessible location, deleting the pointer or cryptographic key from the management information file, deleting the management information file itself, or encrypting the management information file 106 with key data that is stored outside of the bound recording section 105.

In the following example, it will be described how the management information can be made not available by saving a management information file at a non-user-accessible location. The processing of making the management information not available is mainly performed by the bound recording section 105 under the instruction of the CPU 100.

If the encrypted title key has not been recorded yet in the area of the encrypted title key 1610, the title key generating section 1604 reads the title key Kt from the first management information file 106 in the bound recording section 105. If the bound recording section 105 encrypted the title key by a unique technique when recording it, then the title key should be decrypted. The title key Kt is encrypted by the encryption section 1605 with the media unique key Kmu. C2 code is used as the code.

Thereafter, regardless of whether or not the encrypted title key 1610 has been recorded on the first storage medium 116, the bound recording section 105 saves the contents of the first management information file 106 at a non-user-accessible location, which may be a nonvolatile memory managed by the CPU 100 that controls the recorder 101.

By performing this processing, the first management information file 106 is made not available and the user cannot locate the first data file 107 in the bound recording section 105 anymore.

Next, the procedure (4) of recording the access information for the encrypted content file 1612, the encrypted title key 1610, etc. on the first storage medium 116 and making the content readily available will be described.

After the first management information file 106 has been made not available, the first drive 112 records the pointer for the encrypted content data file 1612, etc., on the first storage medium 116 in accordance with the instruction given by the CPU 100. For example, in the file system of the first storage medium 116, the address information of the previously recorded AV and RDI packs is written on a predetermined file arrangement table (not shown) and a navigation information file (not shown) for recording the title information of an encrypted content is written. Furthermore, an address (or pointer) for locating the file arrangement table is written on the navigation information file.

If the encrypted title key has not yet been recorded on the area for the encrypted title key 1610 on the first storage medium 116, then the encryption section 1605 records the encrypted title key Kte in the area for the encrypted title key 1610.

At this point in time, the content on the first storage medium 116 is made available. That is to say, the first player 1613 can detect the storage location of the encrypted content data file 1612 by using the encrypted title key 1610 and management information file 1611. When it is confirmed that the pointer and so on have been recorded, the bound recording section 105 deletes the saved management information file 106. Alternatively, the management information file 106 that has been made not available may be deleted. As another alternative, the pointer to the first data file included in the management information file 106 or the cryptographic key of the first data file may be deleted as well.

As a result of these processing steps, the processing of moving a content from the bound recording section 105 to the first storage medium 116 is completed.

By copying the encrypted content 1612 onto the first storage medium 116 to make the first management information file 106 not available and then recording the pointer to the encrypted content 1612, etc. on the first storage medium 116 in this manner, it is possible to satisfy the rule that no content with a duration exceeding one minute should be playable at both the source of the content on the move and the destination thereof at the same time during the move processing.

It should be noted that after the first management information file 106 has been made not available and before it is confirmed that the pointer and so on have been recorded successfully, the processing might sometimes stop due to the disconnection of power supply, for example. When the processing stops due to such an abnormal operation, neither the first data file 107 on the first bound recording section 105 nor the encrypted content 1612 on the first storage medium 116 is available. If such a state persisted, it would cause a significant loss to the user. Thus, after the recorder 101 has been turned ON again, the first drive 112 deletes the encrypted content 1612 that has been recorded incompletely and the management information file 1611, if any, by reference to the log indicating the progress of the move at the CPU 100. The bound recording section 105 either restores the saved management information file 106 to its original location or makes available the management information file 106 that has been kept not available until then, thereby making the first data file 107 on the bound recording section 105 available. By deleting the remaining encrypted content 1612 and management information file 1611, the availability of the content can be limited to the recorder 101 with more certainty.

The content that has been moved onto the first storage medium 116 successfully can be played back by the first player 1613. In playing back the content, the title key Kt is decrypted using the device key set 1614, MKB decoding processing section 1615, converting section 1616 and decoding section 1617 and the encrypted content 1612 is decrypted by the decoding section 1618 using the title key Kt. The resultant MPEG2-PS stream is decoded by the MPEG decoder 1619 into a baseband signal representing the content 1620.

When the move processing from the bound recording section 105 to the first storage medium 116 is complete, the first management information file 106 on the bound recording section 105 has already been either made not available or deleted but the first data file 107 is still present on the bound recording section 105. That is why by using the access information (i.e., pointer) of the second management information file 108, the first data file 107 can be located. Thus, when the user designates the second management information file 108 through the user interface section 115, the recorder 101 can locate that data file by reference to the pointer. Consequently, if the second management information file 108 is used, the content on the first data file 107 can be played back again.

### E-3. Details of Move Processing about Second Management Information File:

Next, the processing of moving a data file using the second management information file 108 shown in FIG. 13 will be described. If the second management information file 108 is used, then either the first data file 107 or the second data file 109 can be moved to the second storage medium. Thus, that type of move processing will be described more fully. The second storage medium 118 may be a semiconductor memory card such as an SD memory card. The move processing onto the second storage medium 118 is also started in response to the user's command that has been input through the user interface section 115.

A screen for move processing (or screen for dubbing processing; see FIG. 16) is shown by the remote controller 1405. When “SD MP2” or “SD MP4” is selected as the destination of the dubbing/move processing, the move processing onto the second storage medium 118 is started. Suppose the user has selected “SD MP2”. When the storage medium is selected in this manner, a content that can be dubbed or moved is shown among the contents at the source of the dubbing/move processing. In this example, “Momotaro” is supposed to have been selected as in the processing on the first storage medium 116. Thus, the content called “Momotaro” is treated as the object of move processing from the bound recording section 105 to the second storage medium 118.

When the start of move processing is requested through the user interface section 115, the first data file 107, one of the data files about “Momotaro” that are bound-recorded in the bound recording section 105, is copied by the second drive 113 onto the second storage medium 118 and then the second management information file 108 is made not available. Hereinafter, the details of this move processing will be described.

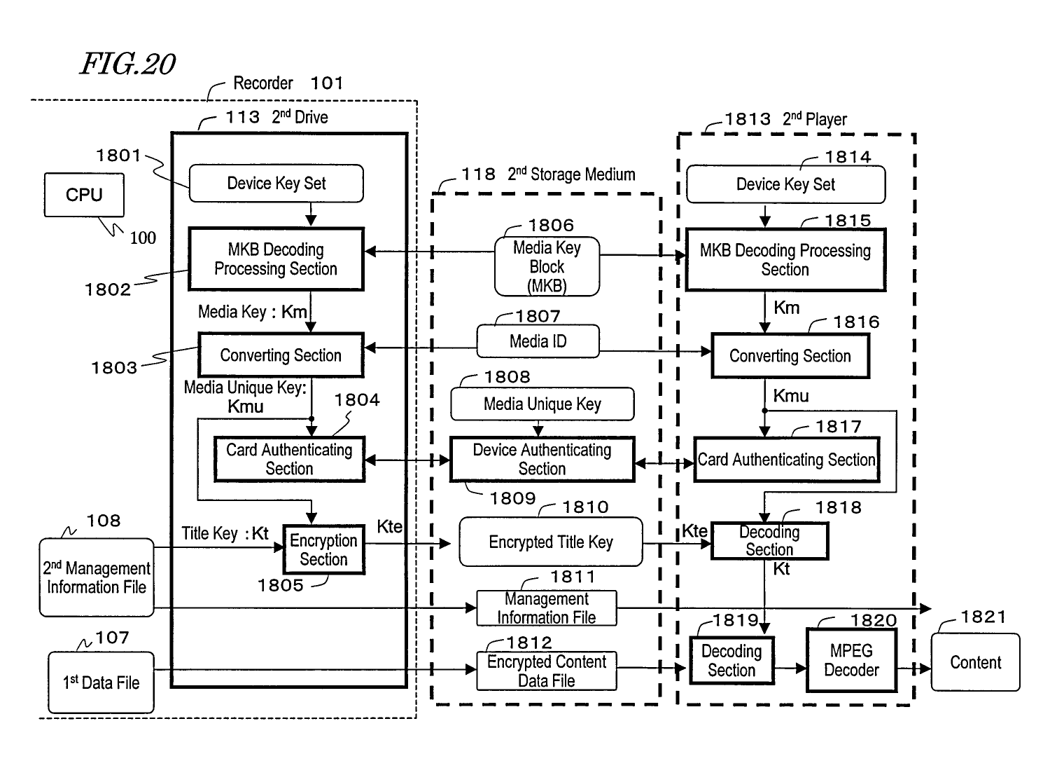

FIG. 20 shows configurations for the second drive 113 of the recorder 101, the second storage medium 118 and the second player 1813. On the second storage medium 118, stored in advance are the media key block (MKB) 1806, the media ID 1807 and media unique key 1808. The MKB 1806 and media ID 1807 are similar to the counterparts of the first storage medium 116. In SD memory cards, the MKB 1806 is defined and the cards are produced based on the data that has been figured out with a new media key Km every time a predetermined number of media (e.g., ten thousand cards) are manufactured. The media unique key Kmu is a key that has been generated by a conversion using the media ID 1807 and has a unique value from one medium to another. The MKB 1806, media ID 1807 and media unique key 1808 are all stored on the second storage medium 118 by a non-alterable technique when the storage medium is manufactured.

The second drive 113 includes a memory card slot, a terminal that connects the memory card inserted into the slot, and a memory card controller that controls the exchange of data with the memory card.

The second drive 113 includes an MKB decoding processing section 1802, a converting section 1803, a card authenticating section 1804, and an encryption section 1805. Also, the second drive 113 retains a device key set 1801.

The MKB decoding processing section 1802 generates a media key Km based on the MKB 1806 and the device key set 1801. The converting section 1803 converts the media key Km with the media ID 1807, thereby generating a media unique key Kmu. The card authenticating section 1804 authenticates the card with the media unique key Kmu. The encryption section 1805 encrypts the title key with the media unique key Kmu.

The second drive 113 records the encrypted title key 1810, management information file 1811, and encrypted content data file 1812 on the second storage medium 118. The second storage medium 118 retains these pieces of information. The SD memory card includes a device authenticating section 1809, which authenticates either the second drive 113 or the recorder 101 by using the media unique key Kmu in the second drive 113 and the media ID 1808 on the second storage medium 118.

The second player 1813 includes an MKB decoding processing section 1815, a converting section 1816, a card authenticating section 1817, decoding sections 1818 and 1819, and an MPEG decoder 1820. Also, the second player 1813 retains a device key set 1814. The MKB decoding processing section 1815 generates a media key Km based on the MKB 1806 and device key set 1814. The converting section 1816 converts the media key Km with the media ID 1807, thereby generating a media unique key Kmu. The card authenticating section 1817 authenticates a given card with the media unique key Kmu. The decoding section 1818 decrypts the encrypted title key 1810 with the media unique key Kmu. The decoding section 1819 decrypts the encrypted content data file 1812 with the title key Kt. And the MPEG decoder 1820 decodes the decrypted content (such as an MPEG2-PS).

In the example illustrated in FIG. 20, the recorder 101 and the second player 1813 are supposed to be two different devices to make their operations understandable more easily. However, a recorder normally has not only a recording function but also a playback function. That is why the recorder 101 and the second player 1813 may have equivalent functional blocks except redundant portions.

Hereinafter, it will be described how to carry out the move processing onto the second storage medium 118, which may be performed in almost the same procedure as that shown in FIG. 18. That is to say, as in the move processing onto the first storage medium 116, the move processing can also be classified into: (1) cryptographic key preprocessing; (2) processing of recording the encrypted content 1812 on the second storage medium 118; (3) processing of making the second management information file 108 in the bound recording section 105 not available; and (4) processing of recording the access information for the encrypted content file 1812, the encrypted title key 1810, etc. on the second storage medium 118 and making the content readily available.

As to the procedure (1) of cryptographic key preprocessing, the same processing steps as those already described with reference to FIG. 17 are carried out until the media unique key Kmu is generated, and the description thereof will be omitted herein. After the media unique key Kmu has been generated, the card authenticating section 1804 of the second drive 113 and the device authenticating section 1809 of the second storage medium 118 authenticate each other as proper device or card with the media unique key Kmu and the media unique key 1808 on the second storage medium 118, respectively. In this authenticating process, the card authenticating section 1804 and device authenticating section 1809 convert random numbers. By using this random number, the card authenticating section 1804 generates a session key Ks.

Next, the procedure (2) of recording the encrypted content file 1812, etc. on the second storage medium 118 will be described.

The area on the second storage medium 118 in which the encrypted title key 1810 is recorded has a capacity to store a plurality of encrypted title keys. Thus, the second drive 113 encrypts the title key Kt that has been generated by the encryption processing section 104 and stores it on the second storage medium 118. It should be noted that the title key Kt is not stored until the content has been stored.

The second drive 113 reads the encrypted MPEG2-PS data from the first data file 107. The title key that was used to encrypt this file will be recorded later as the encrypted title key 1810 on the second storage medium 118. For that reason, the encrypted MPEG2-PS in the first data file 107 can be recorded as it is in the storage area of the encrypted content 1812 of the second storage medium 118. In that case, there is no need to perform the re-encryption process and the content just needs to be read out from the bound recording section 105 and recorded on the second storage medium 118. Consequently, the recording process can be speeded up.

Part of the information stored on the second management information file 108 is stored on the management information file 1811, which may have the same data structure as that shown in FIG. 19.

In this manner, the processing of recording the encrypted content data file 1812 and management information file 1811 on the second storage medium 118 ends. At this point in time, no encrypted title key 1810 for the encrypted content or pointer to the encrypted content 1812 has been recorded yet on the second storage medium 118. That is why even if the second storage medium 118 is removed from the recorder 101, the encrypted content 1812 is still non-usable.

Thereafter, the same processing steps as the counterparts of the move processing onto the first storage medium 116 are carried out. Specifically, the processing of making the second management information file 108 in the bound recording section 105 not available is performed first, and then the encrypted content data file 1812 on the second storage medium 118 is made available. The reason why this processing procedure is adopted is the same as in the move processing onto the first storage medium 116.

The encryption section 1805 reads the title key Kt from the second management information file 108 in the bound recording section 105. If the bound recording section 105 encrypted the title key by a unique technique when recording it, then the title key should be decrypted. The title key Kt is encrypted by the encryption section 1805 with the media unique key Kmu to be the encrypted title key 1810. C2 code is used as the code. When the second drive 113 writes the encrypted title key 1810 on the second storage medium 118, the second drive 113 encrypts it with the session key Ks that has been generated during the mutual authentication process. And the second storage medium 118 that has received the key decrypts it with the session key Ks into the encrypted title key 1810.

Thereafter, the bound recording section 105 makes the management information in the second management information file 108 not available by saving the second management information file 108, for example. A specific example of how to make it not available has already been described for the procedure (3) of move processing onto the first storage medium 116. As a result of this processing, the user can no longer locate the first data file 107 in the bound recording section 105.

Next, the procedure (4) of recording the access information for the encrypted content file 1812, the encrypted title key 1810, etc. on the second storage medium 118 and making the content readily available will be described.

After the second management information file 108 has been made not available, the second drive 113 records the pointer for the encrypted content 1812, etc., on the second storage medium 118 in accordance with the instruction given by the CPU 100. The target of recording is the same as in the example that has been described for the procedure (4) of move processing onto the first storage medium 116. The second drive 113 just needs to write the address information of the pack on a predetermined file allocation table, also write a navigation information file (not shown), and further write an address (pointer) showing the location of the file allocation table on the navigation information file. Furthermore, the second drive 113 records the title key Kte, which has been encrypted by the encryption section 1805, in the area on the second storage medium 118 for the encrypted title key 1810.

As a result of these processing steps, the content on the second storage medium 118 is made available. When it is confirmed that the access information and so on have been recorded, the bound recording section 105 deletes the saved second management information file 108. Alternatively, the second management information file 108 that has been made not available may be deleted.

In this manner, the processing of moving a content from the bound recording section 105 to the second storage medium 118 is completed. The move processing onto the second storage medium 118 may also stop due to an abnormal operation described above. Thus, if such a stop has happened due to some abnormal operation, the second management information file 108 in the bound recording section 105 just needs to be made available again.

The content that has been moved onto the second storage medium 118 successfully can be played back by the second player 1813. In playing back the content, the title key Kt is decrypted using the device key set 1814, MKB decoding processing section 1815, converting section 1816, card authenticating section 1817 and decoding section 1818 and the encrypted content 1812 is decrypted by the decoding section 1819 using the title key Kt. The resultant MPEG2-PS stream is decoded by the MPEG decoder 1820 into a baseband signal representing the content 1821.

Hereinafter, some points to remember when the move processing is performed on the second storage medium 118 will be described with reference to FIG. 13. The second data file 109, which is the destination of the move processing, is accessed based on the set of management information 108-2 on the second management information file 108. Meanwhile, the set of management information 108-1 for the first data file 107 is also included in the second management information file 108. However, the management information to be made not available by the move processing onto the second storage medium 118 is not only the set of management information 108-2 but also the entire second management information file 108. If the first data file 107 were kept accessible without making the set of management information 108-1 unavailable, then the first data file 107 could be moved onto another SD memory card. As described above, normally there is not so much need to make copies of a copyrighted work on the same type of storage media a number of times if the copies are supposed to be used privately. Moves of the same content onto multiple SD memory cards might rather encourage copyright infringement. That is why in a situation where a single management information file includes sets of management information for multiple data files, once a data file, associated with any of those sets of management information, has been moved, no other data file can be moved anymore by using another set of management information.

When the move processing from the bound recording section 105 onto the first storage medium 116 and the move processing from the bound recording section 105 onto the second storage medium 118 are finished, the first and second management information files 106 and 108 have been either made unusable or deleted from the bound recording section 105. Since there are no longer any management information files to point to, neither the first data file 107 nor the second data file 109 is playable anymore. For that reason, those files may be deleted to ensure sufficient bound recording capacity for the bound recording section 105.

If another device is used, then the content on the second storage medium 118 could further be bound-recorded or recorded on another medium. Such recording happens only when the second storage medium 118 has been given such a function. In that case, the first and second management information files 106 and 108 and/or the first and second data files 107 and 109 in the bound recording section 105 just need to be made not available but may be left without being deleted. This is because if the content is moved back from the second storage medium 118 to the bound recording section 105, the first and second management information files 106 and 108 and/or the first and second data files 107 and 109 can be made available again. As a result, the move back operation can be speeded up.

It is predefined by the technical standard of the second storage medium 118 whether or not the second storage medium 118 has been given such a function. For example, a move from a DVD to another type of storage medium is not defined by the technical standard and is not permitted, either. As to SD memory cards, however, their technical standard defines how to move a content from an SD memory card to another type of storage medium. It can be determined depending on whether or not the recorder 101 performs a process that possibly involves a move back according to the type of the destination storage medium of the move processing being carried out from the recorder 101 to the second management information file 108. That is why it can be determined based on the decision result whether the management information files and data files should be deleted or not.

The move processing described above is performed on the combinations of the management information files and data files shown in FIG. 13. However, the move processing may also be carried out on the combinations of management information files and data files shown in FIG. 14, too. For example, if a move is made by using the first management information file 106, first, the user picks either the first data file (with high bit rate) 107 or the second data file (with low bit rate) 109 as the destination of the move processing. And when the move processing is finished in the procedure described above, the first management information file 106 is made not available. Nevertheless, both the first data file (with high bit rate) 107 and the second data file (with low bit rate) 109 will be left as they are in the bound recording section 105 after that. This is because at that point in time, it is still possible to move those data files by using the second management information file 108.

After a further move has been made by using the second management information file 108, however, the second management information file 108 will be made not available. Then, the content will no longer be playable on neither of the two data files 107 and 109. The device may be designed such that both the first data file (with high bit rate) 107 and the second data file (with low bit rate) 109 are deleted from the bound recording section 105 in such a situation. An example of making a move using the first management information file has been described with reference to FIG. 14. However, the same statement also applies to a situation where a move is made by using the second management information file.

If a huge number of management information files and data files that have already been made no longer available were left in the bound recording section 105, then the storage capacity of the bound recording section 105 would soon run short. In that case, the CPU 100 performs a control such that those management information files and data files that have already been made not available are deleted in the order of time stamps (i.e., the oldest file should be deleted earlier than any other file). Alternatively, the titles or any other properties of those unavailable data files may be presented to the user so as to allow him or her to determine which data files should be deleted. For that purpose, information showing the files that have become no longer available may be stored collectively in the recorder 101. For example, the bound recording section 105 may store the identification information of the first or second data file 107 or 109 and the media ID 1807 of the second storage medium 118, on which it has been moved, in a non-user-accessible system area. Then, during move back processing, the bound recording section 105 determines, in accordance with that information, whether or not to make a move back.

If the user is going to move back the first or second data file 107 or 109 that has once been moved onto the second storage medium 118, then the user stores his or her plan in the system area of the bound recording section 105 and the bound recording section 105 performs a control so as not to make the first or second data file 107 or 109 not available or delete it.

As described above, in the recorder and recording method of the present invention, data files in a plurality of recording formats are pointed to by a management information file. And when a move command is received, one of those files pointed to by the management information file is copied onto a storage medium and the management information file is made no longer available. Consequently, the following advantages are achieved: (1) the number of moves to be made never exceeds that of management information files and the copyright of a given content can be protected appropriately; (2) a data file in a recording format that is compatible with the destination storage medium of the move can be prepared in advance, and therefore, the move can be made quickly and the user can use the recorder more conveniently; (3) move can also be made quickly, and without sacrificing the quality, even onto a storage medium that accepts multiple recording formats; and (4) if the same data recording format is adopted for a number of storage media, then the data file can be shared among them and the capacity of the bound recording medium can be used more effectively.

In the preferred embodiment described above, an MPEG2-PS, an MPEG-4 and an MPEG2-PTS are prepared as three different data files and one of them is pointed to by a management information file. Alternatively, the recorder may also be designed such that just one data file is prepared and its recording format is converted into that of the destination storage medium when the move processing is carried out.

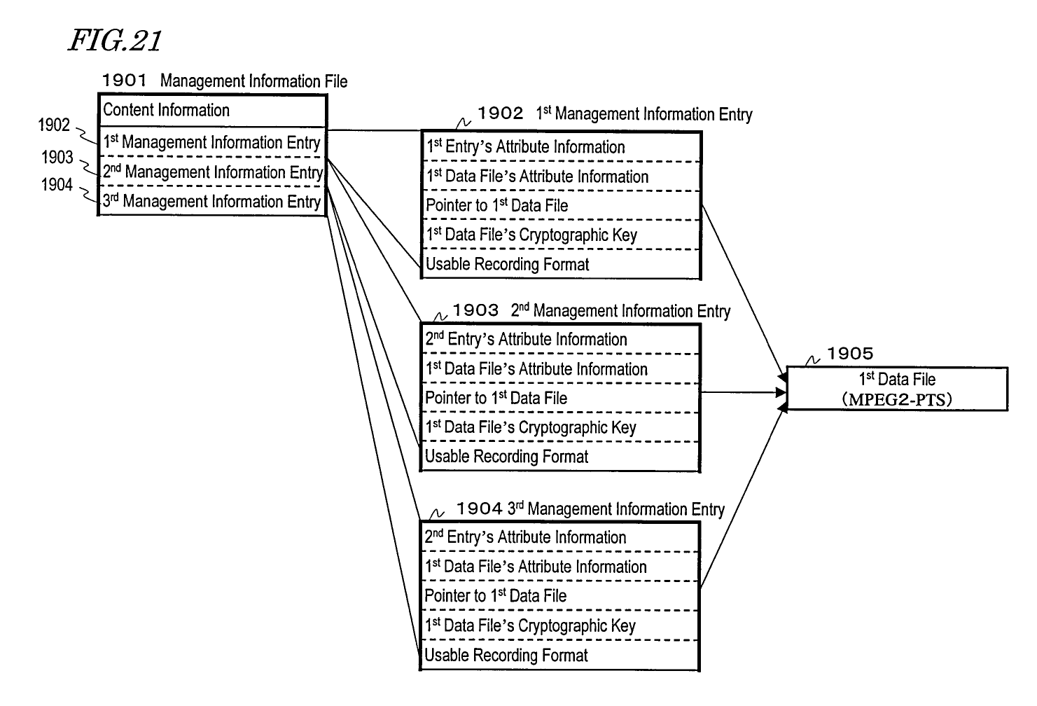

Also, in the preferred embodiment described above, a number of management information files are generated independently of each other. However, only one management information file may be used as well. FIG. 21 shows a management information file 1901 that adopts a different data structure. The management information file 1901 has content information and first to third management information entries 1902 to 1904. That is to say, in the management information file 1901, a number of management information entries are provided for a single management information file. In such an example in which multiple entries are included in a single management information file, those entries correspond to the respective management information files described above (e.g., the management information files 106, 108 and 110 shown in FIG. 13). The present invention can be carried out equally effectively, no matter whether the embodiment using a plurality of management information files or the embodiment providing a plurality of entries for a single piece of management information is adopted. It should be understood that both of these embodiments fall within the scope of the present invention.

The content information is included in each of the multiple management information files in the example shown in FIG. 13 but is combined into one in the example shown in FIG. 21.

Each of the first to third management information entries 1902 to 1904 includes not only the contents of the management information file shown in FIG. 13 but also entry attribute information and usable recording format as well. In the entry attribute information, the type of the destination storage medium of the move and so on are stored. The attribute information also has a flag showing whether that entry is available or not. If the entry is not available, then the data file pointed to by the entry is neither movable nor playable. Supposing the destination storage medium to which the first management information file 1901 is moved is a DVD-RAM, for example, the usable recording format will be MPEG2-PS. Meanwhile, if the destination of the second management information file 1902 is an SD memory card, then the usable recording format will be an MPEG2-PS, an MPEG-4, etc.

As can be seen, the recording formats that are supported by the destination storage medium of the move and that can be converted by the recorder 101 are enumerated as usable recording formats. Data about an MPEG2-PTS is supposed to be stored in the first data file. Various sorts of information about each entry, including title key and copyright protection information, are encrypted with a device unique key, which is not stored in the bound recording section 106 but somewhere else, such that the content would not be used illegally even if the bound recording section 106 were removed from the recorder 101. To prevent leakage, the device unique key may be stored in an encryption processing LSI so as not to be accessible externally. Alternatively, the device unique key may be encrypted by the LSI's own method and stored outside of the LSI. As another alternative, the title key and copyright protection information may be stored in a non-user-accessible storage area, e.g., non-user-accessible storage (not shown) provided separately from the bound recording section 106. There is no problem if the copyright protection information is just read. That is why the copyright protection information does not have to be encrypted but may be just provided with a check code for use to detect the alteration. And if the alteration of the copyright protection information is detected when the content is used, then the use of the content may be either prohibited totally or permitted only under the strictest copyright protected state.

When move processing is started, usable recording formats are presented to the user through the user interface section 115 and the user picks one of those recording formats. When the data file 1905 is copied onto a storage medium, the bound recording code is once decrypted, the recording format is converted, and then the file is encrypted with a key for the storage medium and stored on the storage medium.

By adopting such a design, various pieces of management information about a given content can be combined into a single file and the processing load on the user interface section 115 can be lightened when it is time to show whether or not move can be made on a medium-by-medium basis. In addition, the bound recording medium just needs to have a single data file and the bound recording capacity can be saved.

Alternatively, the bound recording may also be made with the formats shown in FIGS. 13 and 21 combined with each other. For example, a data file with a standard resolution may be prepared as an MPEG2-PS for a DVD-RAM and MPEG2-PS with high resolution, MPEG2-PS with low resolution and so on are also prepared so as to be presented as usable recording formats to the user. In that case, he or she can pick any of the high resolution, standard resolution and low resolution. When the standard resolution is selected, the data file prepared beforehand is used. On the other hand, if the high resolution or low resolution is selected, then the recording format is converted from the MPEG2-PTS, thereby generating a data file.

Furthermore, in the preferred embodiment described above, an example in which a management information file and a data file are bound-recorded on the same bound recording medium has been given. Alternatively, these files may be separately bound-recorded on two different bound recording media. For example, the data file may be bound-recorded on an HDD while the management information file may be bound-recorded in a nonvolatile semiconductor memory that is built in the device. According to such an arrangement, even if the data file were read by another device by removing the HDD, the data file still could not be decrypted and could never be used illegally since there would be no management information file available.

Optionally, the management information file may be encrypted and only the cryptographic key thereof may be bound-recorded on another bound recording medium. It would be cost effective if the cryptographic key were bound-recorded in a semiconductor memory, for example. A semiconductor memory is more expensive than an HDD. But the cryptographic key has a smaller size than the management information file, and therefore, only a small proportion of the semiconductor memory's storage capacity will be consumed to bound-record the cryptographic key.

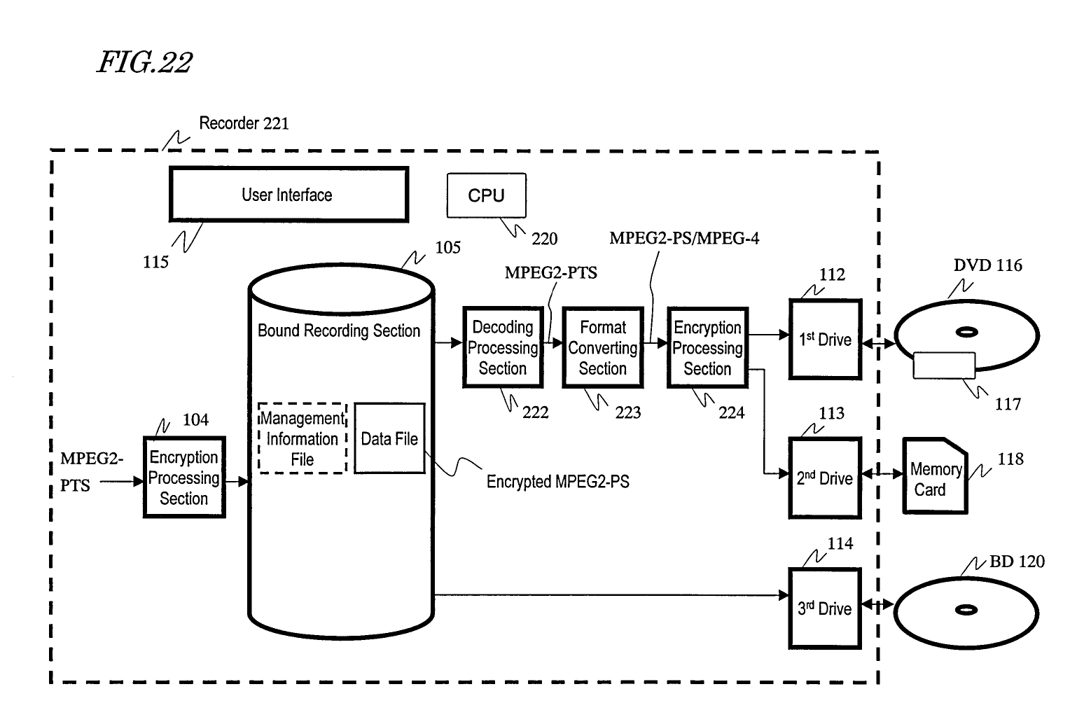

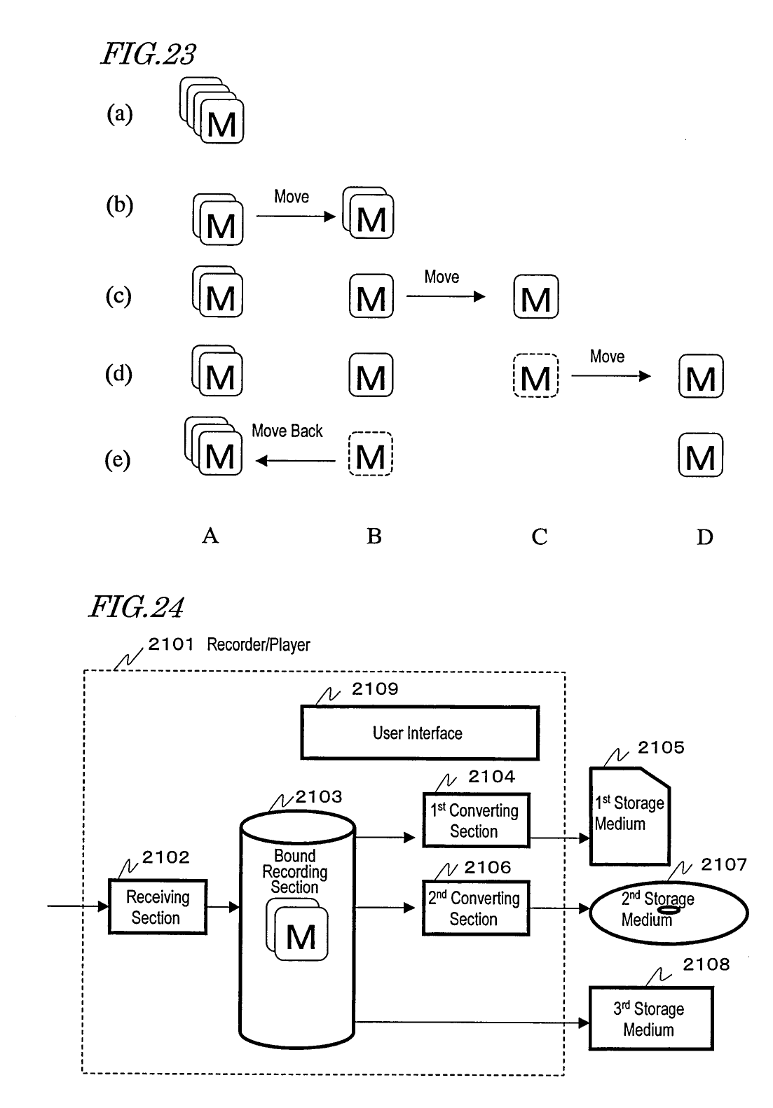

The encryption can be made in the recorder in various manners. FIG. 22 shows an arrangement of functional blocks in a recorder 221 according to another preferred embodiment of the present invention. Each component having the same function as the counterpart of the recorder 101 will be identified by the same reference numeral and the description thereof will be omitted herein. Also, no receiving section 103 is shown for the recorder 221. This means that the receiving section 103 may be either built in the recorder 221 or an external tuner connected to the recorder 221.

Hereinafter, it will be described along the data transmission path in the recorder 221 how to make an encryption. The encryption processing section 104 of the recorder 221 receives an MPEG2-PTS representing a content and encrypts it with a predetermined key. The bound recording section 105 bound-records the data file of the encrypted MPEG2-PTS. In this case, the management information file is bound-recorded, too.

If the content is moved, its processing changes according to the type of the destination storage medium. Specifically, if the destination storage medium is the DVD 116 or the SD memory card 118, then the MPEG2-PTS cannot be moved thereto as it is and needs to have its format converted into an MPEG2-PS, for example. Thus, first, the decoding section 222 decrypts the data file of the MPEG2-PTS with the cryptographic key. Next, the format converting section 223 converts the resultant MPEG2-PTS into an MPEG2-PS. An MPEG-4 stream may also be recorded on the SD memory card 118. That is why the MPEG2-PTS may also be converted into an MPEG-4 stream. The conversion technique is already well known in the art and the description thereof will be omitted herein.

After the format conversion is done, encryption is carried out again using the cryptographic key. The encrypted stream is sent to the first drive 112 or the second drive 113 and recorded on the DVD 116 or the SD memory card 118. In FIG. 22, an MPEG2-PS file 117 that has been recorded on the DVD 116 is shown schematically.

Optionally, only an MPEG-4 stream may be generated in advance and bound-recorded in the bound recording section 105. An MPEG-4 stream has a high data compression rate and will often be viewed or listened to on a mobile terminal that is easily subject to data storage capacity limitations. Even if the user is attempting to have the format of a content converted and get it moved to a mobile terminal just before he or she leaves home, that format conversion will not be convenient for him or her because it takes a lot of time to get the format conversion done. That is why by generating only an MPEG-4 stream in advance, the recorder will come in handier to him or her.

Meanwhile, if the destination storage medium is a BD 120, then the MPEG2-PTS can be moved as it is. Thus, the bound recording section 105 reads the encrypted data file without decrypting it and outputs it to the third drive 114. In response, the third drive 114 records the received data on the BD 120.

Examples of preferred storage media include tapes like D-VHS and dcc and various disks such as recordable compact discs (including CD-R and CD-RW), a mini disc (MD), an Hi-MD, digital versatile discs (including DVD-RAM, DVD-RW and DVD-R), a DVD+RW, a DVD+R, a Blu-ray Disc (BD), an HD-DVD, and an iVDR (Information Versatile Disc for Removable usage). The iVDR refers to a small-sized, lightweight and portable removable hard disk drive that can be used in a broad variety of applications including AV equipment and PCs. As to semiconductor media, a secure digital (SD) memory card, a memory stick, a memory stick pro, or a CompactFlash® may also be used. The present invention is naturally applicable to various other storage media to be developed from now on.

The present invention is also applicable to making a move through a transmission medium such as DTCP.

In the preferred embodiment described above, a video codec format is adopted as the recording format of a data file to be bound-recorded or recorded. However, the recording format does not have to be the video codec. For example, if an AV content has been given, any of various video coding methods (including MPEG2-TS, MPEG2-PS, MPEG-4 and Windows® Media Video (WMV)) or any of various video standards (such as NTSC, PAL and SECAM) with mutually different bit rates, numbers of frames, numbers of pixels and aspect ratios may also be adopted. Meanwhile, if the given content is an audio content, then any of various audio coding methods (including linear PCM, MPEG Audio Layer 3 (MP3), Advanced Audio Coding (AAC) and Windows® Media Audio (WMA)) with mutually different sampling frequencies, bit lengths, numbers of channels and bit rates for compressed audio may also be adopted. A data file, at least one of these parameters of which is different, may be bound-recorded in the bound recording section. It should be noted that these formats are just examples. And the present invention is not limited to these formats.

### INDUSTRIAL APPLICABILITY

The present invention is applicable for use in bound recording a content, which can be moved a limited number of times as defined by its copyright owner, and moving the content to another storage medium in accordance with that limitation.

1. A recorder comprising:
a bound recording section for bound-recording at least one data file and at least one management information file for a content;
a control section for giving an instruction to move the content to a storage medium; and
a drive for recording the content's data on the storage medium,
wherein the management information file includes access information for accessing the data file, and
wherein in response to the instruction to move,
the bound recording section reads the data file of the content in accordance with the access information and outputs the content's data,
the drive records the content's data on the storage medium, and
the control section makes the access information unavailable.

2. The recorder of claim 1, wherein the control section generates access information for accessing the content's data that has been recorded on the storage medium, and
wherein the drive records the generated access information on the storage medium.

3. The recorder of claim 1, wherein the management information file includes storage medium information that specifies a storage medium, to which the content's move has been permitted, and
wherein the bound recording section reads the storage medium information and the control section generates and outputs data to present the storage medium information that has been read.

4. The recorder of claim 1, wherein the management information file includes format information that specifies a recording format, in which the move has been permitted, and
wherein the bound recording section reads the format information and the control section generates and outputs data to present the format information that has been read.

5. The recorder of claim 1, wherein the data file has been encrypted, and
wherein the management information file includes key information for decrypting the data file, and
wherein the bound recording section reads the key information, and
wherein the drive decrypts the data file with the key information that has been read, encrypts the data file again with another key information different from the key information, and then records the content's data on the storage medium.

6. The recorder of claim 1, wherein the data file has been encrypted, and
wherein the management information file includes key information for decrypting the data file, and
wherein the bound recording section reads the key information, and
wherein the drive further records the read key information on the storage medium.

7. The recorder of claim 1, wherein the bound recording section bound-records a number of management information files, the number being specified by the content's provider.

8. The recorder of claim 1, wherein the bound recording section bound-records a plurality of data files and pieces of management information, each of which has a one-to-one relationship with an associated one of the data files, and
wherein the control section gives the instruction to move and designates one of the data files that includes the content to be moved, and
wherein the bound recording section reads and outputs the designated data file, and
wherein the drive records the read data on the storage medium, and
wherein the control section makes unavailable at least the access information of the management information file associated with the data file that has been read.

9. The recorder of claim 1, wherein the bound recording section bound-records a first management information file, a second management information file, and a data file, and
wherein each of the first and second management information files includes access information for accessing the data file, and
wherein the control section gives an instruction to move the content based on the first management information file, and
wherein the bound recording section reads the data file in accordance with the access information of the first management information file, and
wherein the control section makes at least the access information of the first management information file unavailable.

10. The recorder of claim 9, wherein the control section further gives an instruction to move the content, and
wherein the bound recording section reads the data file in accordance with the access information of the second management information file, and
wherein the control section makes at least the access information of the second management information file unavailable.

11. The recorder of claim 1, wherein the bound recording section bound-records a first data file, a second data file and at least one management information file, and
wherein the at least one management information file includes first access information for accessing the first data file and second access information for accessing the second data file, and
wherein the control section gives an instruction to move a content included in the first data file, and
wherein the bound recording section selects a first management information file from the at least one management information file, and reads the first data file in accordance with the first access information included in the first management information file, and
wherein the control section makes unavailable at least the second access information of the first management information file as well as the first access information thereof.

12. The recorder of claim 11, wherein the control section further gives an instruction to move the content included in one of the first and second data files, and
wherein the bound recording section selects a second management information file, which is different from the first management information file, and reads the selected data file in accordance with the access information thereof, and
wherein the control section makes unavailable at least the first and second access information of the second management information file.

13. A recording method comprising the steps of:
bound-recording at least one data file for a content;
bound-recording at least one management information file including access information for accessing the data file;
giving an instruction to move the content to a storage medium;
reading the data file of the content in accordance with the access information and outputting the content's data in response to the instruction to move;
recording the content's data on the storage medium; and
making the access information unavailable.
